(19) United States
(12) Patent Application Publication
(10) Pub. No.: US 2019/0230212 A1
(43) Pub. Date: Jul. 25, 2019

(54) SELECTIVELY FACILITATING ACCESS TO A MOBILE DEVICE

(71) Applicant: EBRAKE TECHNOLOGIES INC., Surrey (CA)

(72) Inventors: Troy Stephen Ralph SPRACKLIN, Surrey (CA); Calman Lion Cachet STEYNBERG, Surrey (CA)

(21) Appl. No.: 16/337,189

(22) PCT Filed: Sep. 26, 2017
(86) PCT No.: PCT/CA2017/051137

§ 371 Date: Mar. 27, 2019

Related U.S. Application Data
(60) Provisional application No. 62/400,600, filed on Sep. 27, 2016.

(30) Foreign Application Priority Data
Sep. 27, 2016 (CA) 2943530

(51) Int. Cl. H04M 1/725; H04W 4/02

(52) U.S. Cl. CPC H04M 1/72569; H04W 4/027; H04W 4/026; H04M 1/72577

(57) ABSTRACT

A method for selectively facilitating access to functionality of a mobile device by a user in a vehicle is provided, which involves causing at least one processor to receive a request for access to the functionality, causing the processor to initially cause access to the functionality to be denied, causing the processor to receive representations of one or more actions taken by the user, causing the processor to determine whether the one or more actions correspond to one or more passenger-related actions that if taken by the user would indicate that the user is not operating the vehicle by determining whether the representations meet at least one passenger-related action criterion, and causing the processor to, in response to determining that the one or more actions meet the criterion, cause the user to be provided access to the functionality of the mobile device. Apparatuses, systems, and computer-readable media are also provided.

### BACKGROUND

### 1. Field

This invention relates to facilitating access to a mobile device and more particularly to a selectively facilitating access by at least one user to functionality of at least one mobile device.

### 2. Description of Related Art

Mobile devices can be used for a multitude of applications and because of their mobility, these devices may be used or usable in various environments, including environments where use of the devices by particular users may be dangerous, undesirable or serve as a distraction and introduce risks to people, property or the completion of various activities. For example, there is a growing problem with users of smartphones and other mobile devices making use of or being distracted by their devices while driving a car, truck, bus, motorbike or other vehicle, which has resulted in an increase in accidents and dangerous situations on the road. Mobile device users are also increasingly making use of their devices in other situations involving increased risks such as in the operation of aircraft, boats, off-road vehicles, construction equipment, agricultural equipment, mining equipment or other operator-controlled equipment or machinery.

In general, mobile devices allow for their use regardless of various risk factors affecting the user or the applicable mobile device, such as the environment that the mobile device is being used in or the set of activities that the user is involved in. Various mobile devices may be configured to limit access by users to the functionality of the device, such as, for example, by providing a lock screen, wherein to unlock the mobile device for use, a user may need to provide simple input such as, for example, by swiping a display. However, such lock/unlock screen feature tends to be rather basic and generally protect the mobile device software simply from being accessed by individuals who do not know the appropriate user password. Since such input may be easily provided by any user who knows the password, regardless of their environment and/or role in the environment at the time the mobile device is being used, this simplistic way of limiting access can be easily overcome by the intended user(s) of the mobile device who have knowledge of the applicable password. As a result, such existing access control mechanisms do not serve as an effective way to prevent or limit use of a mobile device by the user(s) in various circumstances where in doing so the user(s) would be distracted from other activities that they are concurrently carrying out, presenting risks or hazards to themselves, to others, property or the completion of those other activities.

### SUMMARY

The disclosure describes a method for selectively facilitating access to functionality of a mobile device by a user in a vehicle. The method involves causing at least one processor to receive a request for access to the functionality of the mobile device, causing the at least one processor to initially cause access to the functionality of the mobile device to be denied, and causing the at least one processor to receive representations of one or more actions taken by the user. The method also involves causing the at least one processor to determine whether the one or more actions correspond to one or more passenger-related actions that if taken by the user would indicate that the user is not operating the vehicle by determining whether the representations of the one or more actions taken by the user meet at least one passenger-related action criterion, and causing the at least one processor to, in response to determining that the one or more actions meet the at least one passenger-related action criterion, cause the user to be provided access to the functionality of the mobile device.

The method may further involve causing the at least one processor to produce signals for causing a display of the mobile device to display instructions to the user, the instructions prompting the user to take the one or more passenger-related actions.

The one or more passenger-related actions may involve at least one action that is more difficult for an operator of the vehicle to perform than for a user of the vehicle who is not an operator to perform.

The one or more passenger-related actions may involve rotating the mobile device more than a threshold rotation from a first position and interacting with a dynamic user interface while the mobile device is rotated more than the threshold rotation.

The representations of the one or more actions may involve mobile device orientation information representing at least one orientation of the mobile device and causing the at least one processor to apply the at least one passenger-related action criterion may involve causing the at least one processor to determine whether the mobile device orientation information meets at least one orientation threshold.

Causing the at least one processor to determine whether the mobile device orientation information meets the at least one orientation threshold may involve causing the at least one processor to produce signals for causing at least one display to display a user interface for facilitating user engagement and receiving user input and causing the at least one processor to determine whether the mobile device orientation information meets the at least one orientation threshold while the user interface is displayed.

Causing the at least one processor to produce signals for causing the at least one display to display the user interface may involve causing the at least one processor to produce signals for causing the at least one display to display the user interface when the mobile device orientation meets the orientation threshold and causing the at least one processor to cease producing signals for causing the at least one display to display the user interface when the mobile device orientation does not meet the orientation threshold.

The user interface may include at least one moving element for selection by the user.

The mobile device orientation information may involve first orientation information representing orientation of the mobile device at a first time and second orientation information representing orientation of the mobile device at a second time and causing the at least one processor to determine whether the mobile device orientation information meets the orientation threshold may involve causing the at least one processor to determine whether the second orientation represents a rotation from the first orientation of more than a rotation threshold.

The rotation threshold may be greater than about 90 degrees.

Causing the at least one processor to determine whether the mobile device orientation information meets the orientation threshold may involve causing the at least one processor to determine whether the first mobile device orientation represents a substantially vertical orientation of the mobile device wherein the display of the mobile device is substantially vertical before causing the at least one processor to determine whether the second mobile device orientation represents a rotation from the first mobile device orientation of more than a rotation threshold.

The first mobile device orientation may represent the substantially vertical orientation when the mobile device is within a threshold angle of a vertical orientation.

The threshold angle may be about 15 degrees.

Causing the at least one processor to initially cause access to the functionality of the mobile device to be denied may involve causing the at least one processor to receive speed information representing a speed of the mobile device, causing the at least one processor to determine whether the speed represented by the speed information is greater than a threshold speed, and causing the at least one processor to, in response to determining that the speed is greater than the threshold speed, initially cause access to the functionality of the mobile device to be denied.

The user may be a first user of a plurality of users involving one or more additional users other than the first user and causing the at least one processor to cause the user to be provided access to the functionality of the mobile device may involve causing the at least one processor to receive at least one role designation associated with at least one of the one or more additional users.

The method may further involve causing the at least one processor to, in response to receiving the at least one role designation, cause one or more signals to be transmitted to an operator mobile device associated with an operator user of the one or more additional users for causing the operator mobile device to deny access by the operator user to functionality of the operator mobile device.

The method may further involve causing the at least one processor to, in response to receiving the at least one role designation, cause one or more signals to be transmitted to a passenger mobile device associated with a passenger user who is not the operator user for causing the passenger mobile device to provide access to the passenger user to functionality of the passenger mobile device.

The at least one role designation may involve an operator designation.

The disclosure also describes an apparatus for selectively facilitating access to functionality of a mobile device by a user in a vehicle, the apparatus including at least one processor configured to perform any of the above methods.

The disclosure also describes a non-transitory computer-readable medium having stored thereon codes which, when executed by at least one processor, cause the at least one processor to perform any of the above methods.

The disclosure also describes a system for selectively facilitating access to functionality of a mobile device by a user in a vehicle. The system includes provisions for receiving a request for access to the functionality of the mobile device, provisions for causing access to the functionality of the mobile device to be denied, and provisions for receiving representations of one or more actions taken by the user. The system also includes provisions for determining whether the one or more actions correspond to one or more passenger-related actions that if taken by the user would indicate that the user is not operating the vehicle by determining whether the representations of the one or more actions taken by the user meet at least one passenger-relate action criterion, and provisions for, in response to determining that the one or more actions meet the at least one passenger-related action criterion, causing the user to be provided access to the functionality of the mobile device.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a perspective view of an environment wherein a mobile device in accordance with various embodiments of the invention is configured to act as an apparatus for selectively facilitating access by a user to functionality of the mobile device;

FIG. 2 is a perspective view depicting the mobile device shown in the environment of FIG. 1 being moved from a first orientation to a second orientation in accordance with various embodiments of the invention;

FIG. 3 is a schematic view of the mobile device shown in the environment of FIG. 1 including a processor circuit in accordance with various embodiments of the invention;

FIG. 4 is a flowchart depicting blocks of code for directing the mobile device shown in FIG. 3 to effect selective access functions in accordance with various embodiments of the invention;

FIG. 5 is a representation of an exemplary display that may be displayed by the mobile device shown in FIG. 3 in accordance with various embodiments of the invention;

FIG. 6 is a flowchart depicting blocks of code that may be included in the blocks of code of the flowchart shown in FIG. 4 in accordance with various embodiments of the invention;

FIG. 7 is a representation of an exemplary speed record that may be used by the mobile device shown in FIG. 3, in accordance with various embodiments of the invention;

FIG. 8 is a flowchart depicting blocks of code that may be included in the blocks of code of the flowchart shown in FIG. 4 in accordance with various embodiments of the invention;

FIG. 9 is a representation of an exemplary display that may be displayed by the mobile device shown in FIG. 3 in accordance with various embodiments of the invention;

FIG. 10 is a representation of an exemplary orientation record that may be used by the mobile device shown in FIG. 3, in accordance with various embodiments of the invention;

FIG. 11 is a representation of an exemplary orientation record that may be used by the mobile device shown in FIG. 3, in accordance with various embodiments of the invention;

FIG. 12 is a representation of an exemplary rotation record that may be used by the mobile device shown in FIG. 3, in accordance with various embodiments of the invention;

FIG. 13 is a representation of an exemplary display that may be displayed by the mobile device shown in FIG. 3 in accordance with various embodiments of the invention;

FIG. 14 is a representation of an exemplary user interface that may be provided by the mobile device shown in FIG. 3 in accordance with various embodiments of the invention;

FIG. 15 is a representation of an exemplary user input record that may be used by the mobile device shown in FIG. 3, in accordance with various embodiments of the invention;

FIG. 16 is a representation of an exemplary display that may be displayed by the mobile device shown in FIG. 3 in accordance with various embodiments of the invention;

FIG. 17 is a representation of an exemplary display that may be displayed by the mobile device shown in FIG. 3 in accordance with various embodiments of the invention;

FIG. 18 is a representation of an exemplary user interface that may be provided by the mobile device shown in FIG. 3 in accordance with various embodiments of the invention;

FIG. 19 is a schematic representation of a system for facilitating access to the functionality of a plurality of mobile devices including the mobile device shown in FIG. 3, in accordance with various embodiments of the invention;

FIG. 20 is a perspective view of an environment wherein the system shown in FIG. 19 may be used in accordance with various embodiments of the invention;

FIG. 21 is a schematic view of a second mobile device of the system shown in FIG. 19 including a processor circuit in accordance with various embodiments of the invention;

FIG. 22 is a schematic view of a third mobile device of the system shown in FIG. 19 including a processor circuit in accordance with various embodiments of the invention;

FIG. 23 is a flowchart depicting blocks of code that may be included in the blocks of code of the flowchart shown in FIG. 4 in accordance with various embodiments of the invention;

FIG. 24 is a flowchart depicting blocks of code that may be included in the blocks of code of the flowchart shown in FIG. 23 in accordance with various embodiments of the invention;

FIG. 25 is a representation of an exemplary display that may be displayed by the mobile device shown in FIG. 3 in accordance with various embodiments of the invention;

FIG. 26 is a representation of a user profile record that may be used in the system shown in FIG. 19 in accordance with various embodiments of the invention;

FIG. 27 is a representation of an exemplary display that may be displayed by the mobile device shown in FIG. 3 in accordance with various embodiments of the invention;

FIG. 28 is a representation of a user profile record that may be used in the system shown in FIG. 19 in accordance with various embodiments of the invention;

FIG. 29 is a representation of an exemplary display that may be displayed by the mobile device shown in FIG. 3 in accordance with various embodiments of the invention;

FIG. 30 is a representation of a user profile record that may be used in the system shown in FIG. 19 in accordance with various embodiments of the invention;

FIG. 31 is a representation of a user profile record that may be used in the system shown in FIG. 19 in accordance with various embodiments of the invention;

FIG. 32 is a representation of a user profile record that may be used in the system shown in FIG. 19 in accordance with various embodiments of the invention;

FIG. 33 is a flowchart depicting blocks of code for directing the second mobile device shown in FIG. 21 to effect selective access functions in accordance with various embodiments of the invention;

FIG. 34 is a representation of an exemplary display that may be displayed by the second mobile device shown in FIG. 21 in accordance with various embodiments of the invention;

FIG. 35 is a flowchart depicting blocks of code for directing the third mobile device shown in FIG. 22 to effect selective access functions in accordance with various embodiments of the invention;

FIG. 36 is a representation of an exemplary display that may be displayed by the third mobile device shown in FIG. 22 in accordance with various embodiments of the invention;

FIGS. 37A and 37B depict a flowchart depicting blocks of code that may be included in the blocks of code of the flowchart shown in FIG. 4 in accordance with various embodiments of the invention; and

FIG. 38 is a representation of an exemplary display that may be displayed by the mobile device shown in FIG. 3 in accordance with various embodiments of the invention;

### DETAILED DESCRIPTION

Aspects, features and embodiments of the invention are described with reference to illustrative embodiments and figures. Generally, there are provided methods, systems, apparatuses, and computer-readable media for selectively facilitating access by one or more users to functionality of one or more mobile devices. Methods described herein are computer-implemented methods.

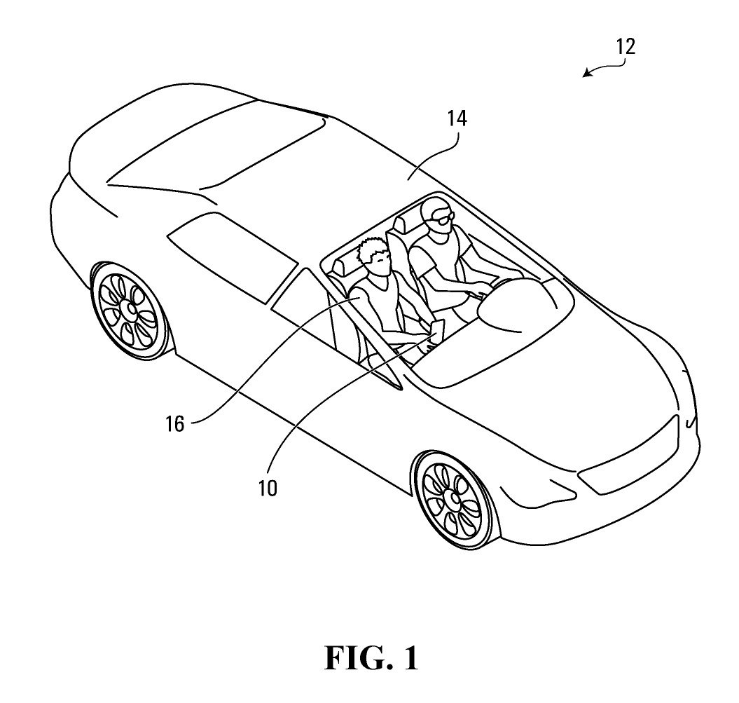

Referring to FIG. 1, there is shown a mobile device 10 being used in an exemplary environment 12 in accordance with one embodiment of the invention. In the embodiment shown in FIG. 1, the environment 12 includes a vehicle 14, more particularly an automobile, and the mobile device 10 is being used by a user 16 who is a passenger in the vehicle 14. However, the environment under which selective access to functionality of the mobile device 10 may be controlled can vary in other embodiments. For example, in other embodiments, the vehicle 14 may be a truck, bus, motorcycle or other form of vehicle, either for on-road or off-road use. In some embodiments, for example, the vehicle 14 may be a public transit or mass transit vehicle. In some embodiments, the vehicle 14 may be an aircraft, a boat, a train or some form of equipment or machinery operated by an operator (e.g. construction equipment, agricultural equipment, mining equipment or other mechanical equipment).

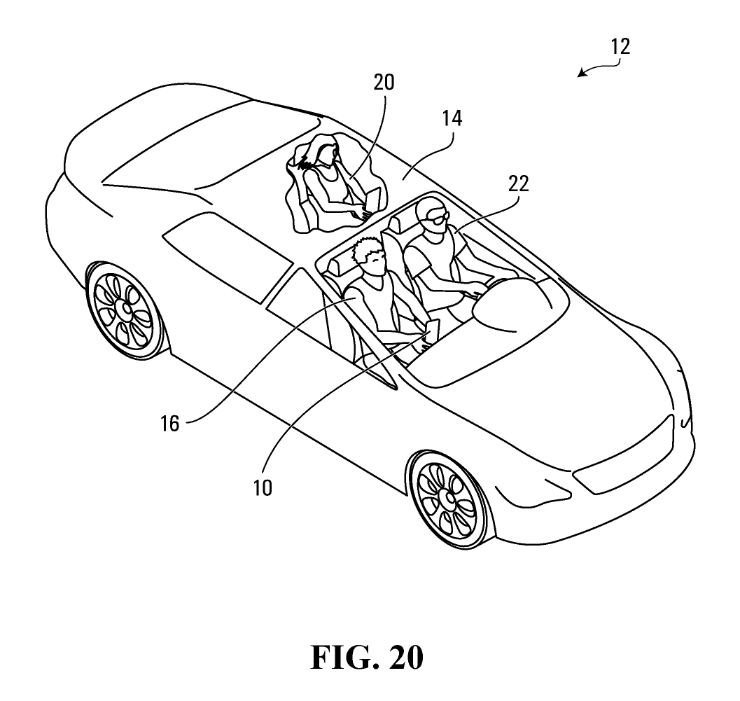

In various embodiments, the mobile device 10 may be configured to act as an apparatus for selectively facilitating access by the user 16 to functionality of the mobile device 10. In some embodiments, the way that the device selectively facilitates access by the user 16 to the functionality of the mobile device 10 may allow the mobile device 10 to discourage or disable use by a user in the environment 12 where use of the mobile device 10 may be dangerous, undesirable or serve as a distraction and introduce risks to people, property or the completion of various activities. While in the environment 12 shown in FIG. 1, the user 16 is shown as the only passenger in the vehicle 14. In various embodiments, the user 16 may be one of a plurality of passengers. For example, as shown in FIG. 20, the user 16 may be one of 3 passengers. In some embodiments, the user 16 may be one of any number of passengers including more than 3 passengers, for example.

In some embodiments, use of the mobile device 10 in the environment 12 by an operator or driver of the vehicle 14 may be dangerous or distracting when the vehicle 14 is being operated or in motion, whereas use of the mobile device 10 by the user 16 as a passenger (as opposed to the operator or driver) of the vehicle 14 shown in FIG. 1 may be safe. Accordingly, in various embodiments the mobile device 10 may be configured to selectively facilitate access to functionality of the mobile device 10 by allowing for access to a passenger of the vehicle 14 but disabling access to an operator or driver of the vehicle 14.

The mobile device 10 may be configured to selectively facilitate access to functionality of the mobile device 10. For example, in some embodiments, the mobile device 10 may have installed thereon an application or program which, when executed, causes the mobile device 10 to be configured to selectively facilitate access to functionality of the mobile device 10. In some embodiments, the mobile device 10 may be configured such that the functionality for selectively facilitating access to functionality of the mobile device 10 is implemented at the operating system level.

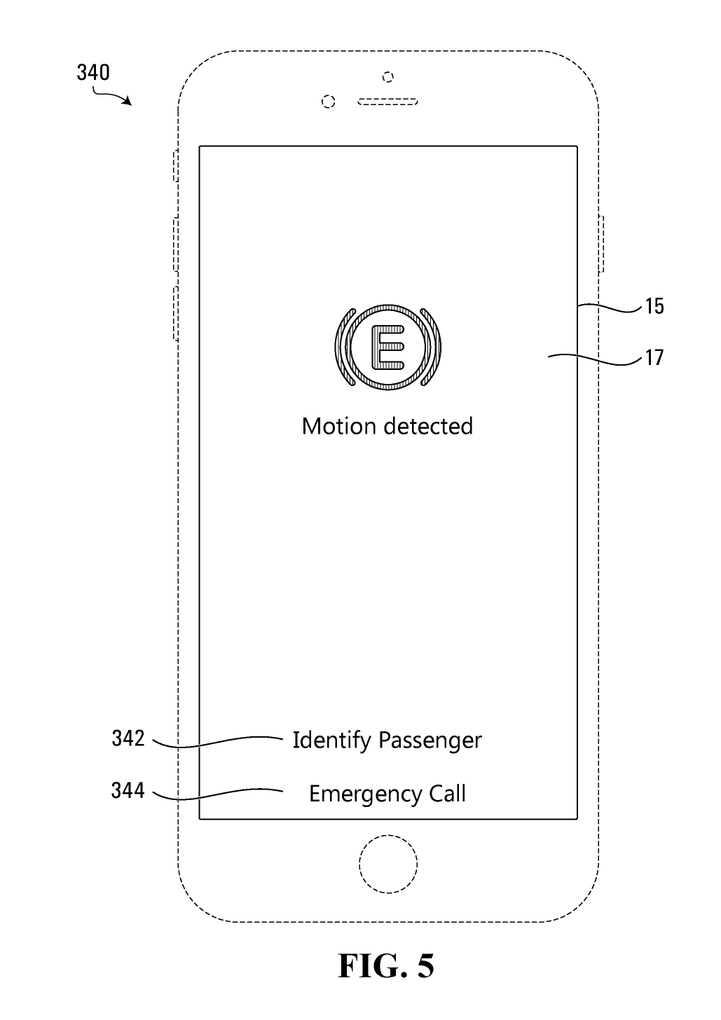

Referring to FIGS. 1 and 5, the user 16 may request access to the functionality of the mobile device 10 by interacting with the mobile device 10 or turning the mobile device 10 on, for example by interacting with a touchscreen display 15 (e.g. see FIG. 5) of the mobile device 10 and/or by pressing an input on the mobile device 10 (e.g. such as a power button or other button on the device). In various embodiments, the touchscreen display 15 displays a user interface 17 for supporting user interaction with the mobile device 10 and various programs or apps executable on the mobile device 10. The mobile device 10 may be configured to receive the request and to initially deny access to programs, apps or data on the mobile device 10 or to other functionality of the mobile device 10 supported by the operating system installed on the mobile device or hardware or firmware on the mobile device 10.

In some embodiments, the mobile device 10 may be configured to determine whether the device 10 is, relative to being stationary on a ground location (e.g. surface or subsurface), moving at a speed greater than a threshold speed, such as, for example 2 m/s, and may be configured to deny access to the functionality of the mobile device if the device is moving at a speed greater than the threshold speed, but to otherwise allow access if the device is not moving at a speed greater than the threshold speed. In some embodiments, this feature involving a threshold speed limit may facilitate easy access to the functionality of the mobile device 10, when the mobile device 10 is detected to be not moving or not moving in excess of the threshold speed. This can have the advantage of supporting safer use of the mobile device 10 by an operator or driver of a vehicle or the like.

In order to gain access to or unlock the mobile device 10, the user may be required to perform one or more actions to show that the user is not an operator or driver of the vehicle. The mobile device 10 may be configured to receive representations of one or more actions taken by the user and to determine if the user performed actions show or indicate that the user is not an operator or driver of the vehicle.

In some embodiments, the mobile device 10 may be configured to display instructions to the user to prompt the user to take one or more passenger-related actions that if taken by the user would indicate that the user is not operating or driving the vehicle and the user may take the one or more actions in response to viewing the instructions. The mobile device 10 may be configured to monitor sensors for and to receive sensor information representing or related to the one or more passenger-related actions.

In some embodiments, the one or more passenger-related actions may include an action that is more difficult or unsafe for an operator or driver of the vehicle to perform while the vehicle is in motion than for a passenger in the vehicle to perform. For example, the one or more passenger-related actions may include an action that is very difficult or extremely difficult for a car driver to perform while driving, but would be relatively easy or straight-forward for a passenger to perform while the car is in motion. In some embodiments, by detecting the one or more passenger-related actions, the mobile device 10 may be able to detect that the current user of the mobile device 10 is a passenger or is not an operator or driver of the vehicle.

The mobile device 10 may be configured to determine whether the one or more actions taken by the user correspond to one or more passenger-related actions by determining whether the representations of the one or more actions taken by the user meet at least one passenger-related action criterion that the mobile device 10 is configured to detect or identify. The mobile device may be configured to, in response to determining that the one or more actions taken by the user meet the at least one passenger-related action criterion, cause the functionality of the mobile device 10 to be accessible to the user.

In some embodiments, the mobile device 10 may be configured to determine whether one or more actions taken by the user meet the at least one passenger-related action criterion by initially entering an access pre-conditioning state and then once one or more criteria is or are satisfied, entering an access assessment state.

In some embodiments, in the access pre-conditioning state, the mobile device 10 may be configured to assess orientation properties of the mobile device 10, configuration properties of the mobile device 10, or both orientation and configuration properties of the mobile device 10, to determine whether to enter the access assessment state. For example, in some embodiments, the mobile device 10 may be configured to apply at least one criterion to representations of orientations of the mobile device to determine whether the mobile device 10 has been moved into an orientation that makes the mobile device 10 difficult or impossible to interact with or view while operating the vehicle 10. If the mobile device 10 determines that the at least one criterion has been satisfied, the mobile device 10 may proceed into the access assessment state. In some embodiments, at least some of the orientation and/or configuration properties may be determined relative to a heading.

When the mobile device 10 is in the access assessment state, the mobile device may be configured to assess whether access should be granted to the user. In some embodiments, in the access assessment state the mobile device 10 may be configured to run one or more access control tests and, if the tests are passed the mobile device 10 may classify the current user as a passenger and allow the user access to the functionality of the mobile device. In various embodiments, the access control tests may be cognitive tests.

In some embodiments, the mobile device 10 may be configured to facilitate one or more access control tests or cognitive tests which require a sufficient amount of attention such that the vehicle 14 cannot be operated by the user while the user is completing the tests. For example, in some embodiments, the one or more access control tests may require all or substantially all of the attention of the user 16 for a period of time. The period of time may be one that is longer than a period of time during which a user could safely be distracted from operating the vehicle 14, for example.

In some embodiments, the one or more access control tests may involve a user classification test and the mobile device 10 may be configured to classify the user 16 in a role based on the results of the tests. For example, in some embodiments, the mobile device 10 may be configured to classify the user 16 as an operator or as a user that is not an operator. In the illustrative embodiments shown herein, the operator is a driver of the vehicle 14, which is a car. In some embodiments, a user that is an operator may be, by way of example, a driver of a car, bus, truck, or off-road vehicle, a pilot, a person who steers or controls a boat, a crane operator, an operator of mining equipment or agricultural equipment, or another operator of a machine or device that requires a user's attention to safely control.

In some embodiments, the one or more passenger-related actions may involve moving the mobile device 10 into an orientation wherein the display of the mobile device 10 is difficult, unsafe or impossible for an operator or driver to view and/or use to provide input, while safely driving and watching the road or otherwise operating the vehicle. The mobile device 10 may be configured to monitor for these actions while in an access pre-conditioning state. In some embodiments, once the mobile device 10 has been moved into the orientation wherein the display is difficult to view if the user is the operator in the operator position of the vehicle (e.g. the driver seat), the mobile device 10 may enter the access assessment state and provide a user interface to the user 16, such that the user 16 is required to provide input to the mobile device. In various embodiments, because the user input must be provided after the mobile device 10 has been moved into a difficult orientation for an operator, it may be difficult or impossible for an operator of the vehicle 14 to pass any test provided during the access assessment state. This may discourage the operator or driver from attempting to perform the passenger-related actions, as the operator would know that it would be difficult to do.

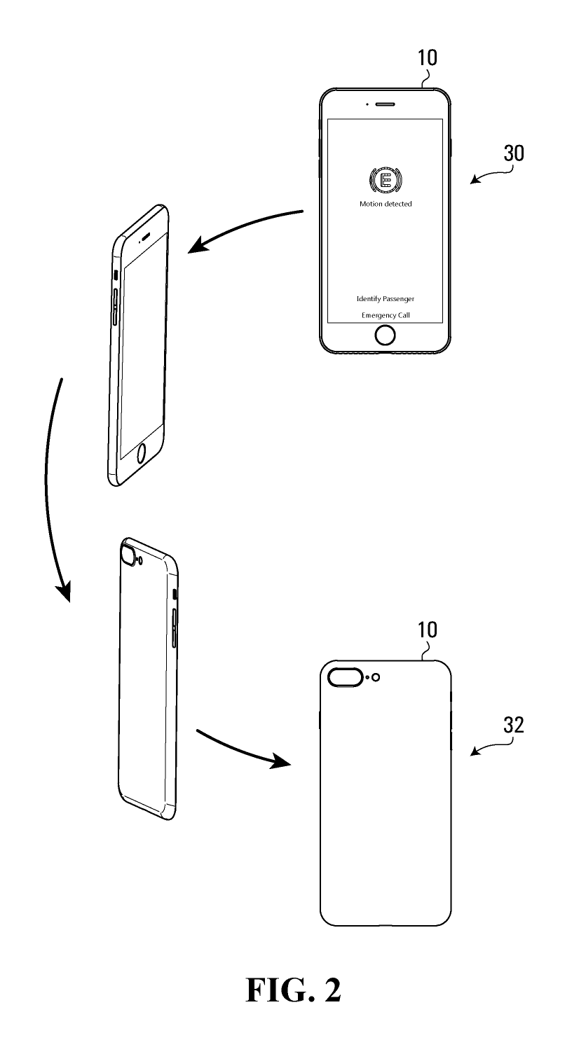

For example, in some embodiments, the passenger-related actions may involve rotating the mobile device 10 more than a threshold rotation from a forward position and interacting with a user interface on the mobile device 10 once the mobile device 10 is rotated more than the threshold rotation such that it would be difficult, unsafe, or potentially impossible for an operator or driver to view and/or use the mobile device 10 to provide input, while driving and watching the road. For example, referring to FIG. 2, the passenger related actions may involve rotating the mobile device 10 from a first orientation 30 wherein the mobile device 10 is held in front of the user 16, for example, in a generally or substantially vertical orientation, through to a second orientation 32 wherein the mobile device 10 has been rotated more than a threshold rotation, for example, about 100 degrees in one embodiment. In other embodiments, the threshold rotation may be at least about 90 degrees; in yet other embodiments, the threshold rotation may be in the range of about 90 degrees to about 180 degrees.

In various embodiments, the first orientation 30 may correspond to an orientation generally as shown for the mobile device 10 in FIG. 1, where the mobile device 10 is in front of the user 16. Accordingly, the second orientation 32 may correspond to an orientation wherein a user interface portion of the mobile device 10 is facing generally backwards or generally away from a line of sight of a front-facing operator of the vehicle 14, and in various embodiments may not be easily viewed by the operator while operating the vehicle 14. In various embodiments, a user using the mobile device 10 in the second orientation may be easily identified, for example, by law enforcement or other people or drivers, as someone who is using the mobile device 10 and so an operator may be discouraged from attempting to use the mobile device while in the second orientation 32 shown in FIG. 2.

In some embodiments, the user interface provided by the mobile device 10, for example, while in the second orientation 32 shown in FIG. 2, may provide a cognitive test. The user interface may display on-screen instructions that would be difficult, unsafe, or impossible for an operator driver to react to. The user interface may display a dynamic user interface or may include moving or dynamic elements and/or multi-touch elements as part of the completion criteria for determining that the user is a passenger, such that it would be difficult, unsafe, or impossible to interact with the user interface sufficiently to allow for the vehicle to be driven.

In some embodiments, provision of such a dynamic user interface on the user interface as part of the completion criteria for determining that the user is a passenger, would make use of the mobile device 10 difficult, unsafe, or impossible to interact with without focusing on the display of the mobile device 10 and generally away from driving or operating the vehicle for an extended period of time or in a manner that would quickly make driving or operation of the vehicle difficult or impossible for the user to accomplish while using the mobile device 10. Use of one or more of the foregoing features may help to discourage operators or drivers of vehicles from attempting to interact with the interface to the mobile device 10 while the vehicle is being driven, since such interaction would require focus away from the road for an extended period of time or in a manner that would make driving or operating the vehicle difficult or impossible for even a short period of time.

Mobile Device

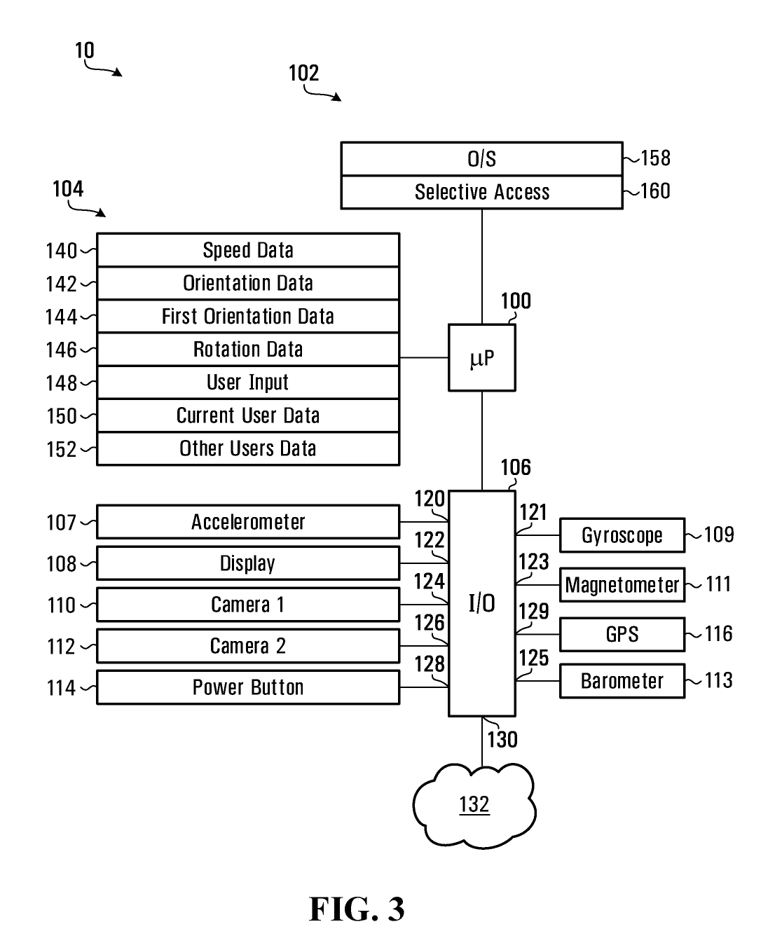

Referring to FIG. 3, a schematic view of a processor circuit for implementing the mobile device 10 according to one embodiment is shown. In various embodiments, the mobile device 10 may include any of a variety of personal computing devices including a smartphone, a tablet, a phablet, a personal digital assistant, or a cellular phone, for example. In various other embodiments, the mobile device 10 may be a wearable computing device (e.g. such as Google Glass™ or wireless watches or the like), or another form of mobile computing device.

Referring still to FIG. 3, the mobile device 10 includes a processor circuit including a mobile device processor 100 and a program memory 102, a storage memory 104, and an input/output (I/O) interface 106, which are in communication with the mobile device processor 100. In the embodiment shown in FIG. 3 for illustration purposes, the mobile device 10 also includes an accelerometer 107, a gyroscope 109, a magnetometer 111, a barometer 113, a touch screen display 108, a front facing camera 110, a rear facing camera 112, a power button 114, and a global positioning system (“GPS”) receiver 116. The I/O interface 106 includes an interface 120 for communicating with the accelerometer 107, an interface 121 for communicating with the gyroscope 109, an interface 123 for communicating with the magnetometer 111, an interface 125 for communicating with the barometer 113, an interface 122 for communicating with the display 108, an interface 124 for communicating with the front facing camera 110, an interface 126 for communicating with the rear facing camera 112, an interface 128 for communicating with the power button 114, and an interface 129 for communicating with the GPS receiver 116.

The I/O interface 106 also includes one or more communication interfaces, including an interface 130 for communication with one or more other mobile devices. In some embodiments, the interface 130 may enable a Bluetooth™ connection, which may be implemented on an independent Bluetooth™ Channel, for example. In some embodiments the Bluetooth™ connection may be initiated using device mating, for example. In some embodiments, the interface 130 may facilitate networked communication via a network 132, for example, and may include one or more wireless network interfaces each with an input/output for connecting to one or more wireless networks, through which communications may be conducted with devices connected to the network. In various embodiments the interface 130 may enable wireless communication such as over a cellular or mobile phone network connection, a Wi-Fi™ connection, a WiMAX™ connection, a Bluetooth™ connection, or using ultrasonic communications or another form of wireless communication, for example. In some embodiments, the interface 130 may enable communication with the Internet.

In some embodiments, each of the interfaces shown in FIG. 3 may include one or more interfaces and/or some or all of the interfaces included in the I/O interface 106 may be implemented as combined interfaces or a single interface.

Processor-executable program codes for directing the mobile device processor 100 to carry out various functions are stored in the program memory 102. The program memory 102 includes a block of codes 158 for directing the mobile device to perform operating system functions and a block of codes 160 for directing the mobile device 10 to effect selective access functions. The block of codes 158 may define an operating system of the mobile device. For example, the operating system may be iOS™, Android™, Windows Phone™, Blackberry 10™0 or another type of operating system configured to facilitate functionality of a mobile device. The block of codes 160 may define a selective access application or module. In this specification, it may be stated that certain encoded entities such as applications or modules perform certain functions. Whenever an application, module or encoded entity is described as taking an action, as part of, for example, a function or a method, it will be understood that a processor (e.g. the mobile device processor 100) is directed to take the action by way of programmable codes or processor-readable and processor-executable instructions defining or forming part of the application, module or encoded entity and/or cause another component, for example a part of the mobile device 10 shown in FIG. 3 or the system 520 shown in FIG. 19, to take the action.

The storage memory 104 includes a plurality of storage locations including location 140 for storing speed data, location 142 for storing orientation data, location 144 for storing first orientation data, location 146 for storing rotation data, location 148 for storing user input data, location 150 for storing current user data, and location 152 for storing other user data. In various embodiments, the blocks of codes 158 and 160 may include one or more blocks of code stored in one or more locations in memory and the locations 140-152 may each include one or more locations in memory. In various embodiments, the plurality of storage locations may be stored in a database in the storage memory 104.

Each of the program memory 102 and storage memory 104 may be implemented as one or more storage devices including random access memory (RAM), a hard disk drive (HDD), a solid-state drive (SSD), a network drive, flash memory, a memory stick or card, any other form of non-transitory computer-readable memory or storage medium, and/or a combination thereof. In some embodiments, the program memory 102, the storage memory 104, and/or any portion thereof may be included in a device separate from the mobile device 10 and in communication with the mobile device 10 via the I/O interface 106, such as, for example, via the interface 130. In various embodiments, other program memory, blocks of code, storage memory, and locations in memory described herein may be implemented generally similarly to as described above for the program memory 102 and the storage memory 104.

Facilitating Selective Access

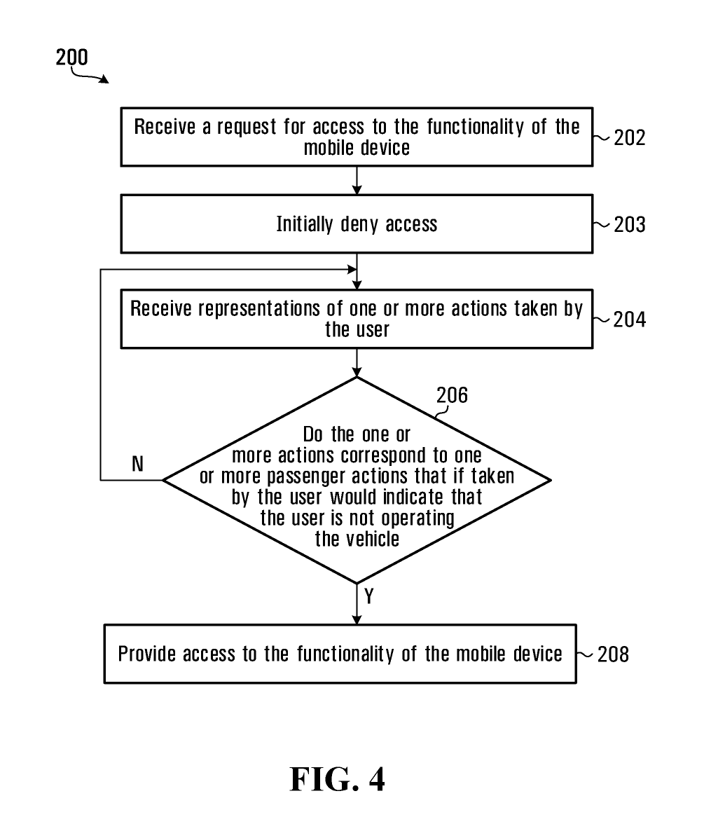

In various embodiments, the mobile device 10 shown in FIGS. 1 to 3 may be configured to selectively facilitate access by a user to functionality of the mobile device 10. Referring to FIG. 4, a flowchart depicting blocks of code for directing the mobile device processor 100 shown in FIG. 3 to perform selective access functions in accordance with one embodiment is shown generally at 200. In some embodiments, the flowchart 200 may be encoded in the block of codes 160 shown in FIG. 3 for example and may act as part of the selective access application.

In some embodiments, a user action may, upon detection by the mobile device 10 or the operating system of or a program on the mobile device 10, trigger the operating system of the mobile device 10 to invoke the flowchart 200, for example, when the user action is identified as directing the operating system to execute the selective access application. In some embodiments, the flowchart 200 may be initiated when it is determined that the mobile device 10 is in an environment where selective access should be provided, such as, for example when it is determined that the mobile device 10 either is in motion in excess of a threshold speed or more generally may have entered a vehicle. In some embodiments, it may be assumed that the mobile device 10 is being used in such an environment, and the flowchart 200 may be initiated upon start-up of the mobile device 10. In some embodiments, the flowchart 200 may be implemented at the operating system level and the codes depicted by the flowchart 200 may be included in the operating system codes. In some embodiments, the flowchart 200 may be continuously executed or executable when the mobile device 10 is on.

Referring to FIG. 4, the flowchart 200 begins with block 202 which directs the mobile device processor 100 shown in FIG. 3 to receive a request for access to the functionality of the mobile device 10. In some embodiments, block 202 may direct the mobile device processor 100 to monitor the I/O interface 106 shown in FIG. 3, and to wait for a request for access to the functionality of the mobile device 10.

In some embodiments, a user using the mobile device 10 may request access by attempting to use or power on the mobile device 10. For example, the request for access may involve the user interacting with or touching the display 108 and/or actuating the power button 114 on the mobile device 10 shown in FIG. 3 such that a signal is produced and sent to the mobile device processor 100 via the I/O interface 106. In some embodiments, block 202 may direct the mobile device processor 100 to monitor the interfaces 122 and/or 128 shown in FIG. 3 for an attempt to use or power on the mobile device 10 and when the display is interacted with and/or the power button is pressed, for example, to receive the generated signal via the interfaces 122 and/or 128, the signal representing a request for access to the functionality of the mobile device.

When a request for access to the functionality of the mobile device 10 is received, block 203 may direct the mobile device processor 100 to initially cause access to be denied. In some embodiments, block 203 may direct the mobile device processor 100 to cause the display 108 of the mobile device 10 to display a lock-out display, for example, as shown at 340 in FIG. 5. In various embodiments, the lock-out display 340 may include a selectable emergency call element 344 which, when selected by a user, may facilitate the user making an emergency call. In various embodiments, the displays provided by the mobile device 10 may each include an emergency call element generally similar to the emergency call element 344.

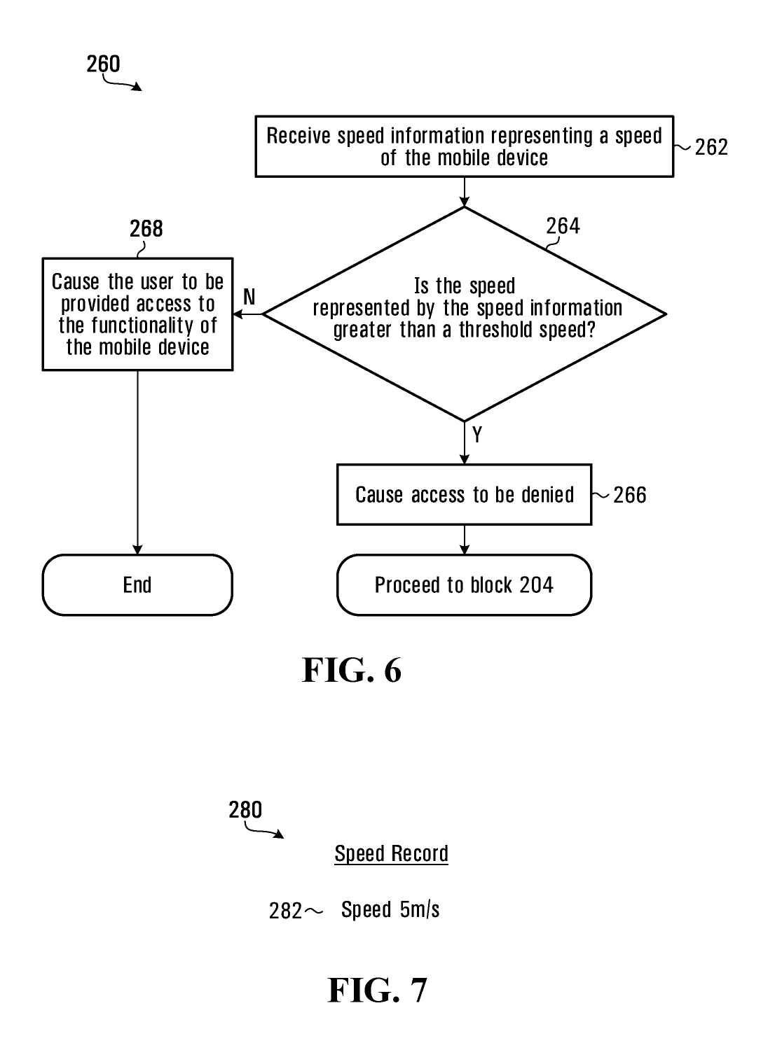

In some embodiments, block 203 may direct the mobile device processor 100 to only display the lock-out display 340 shown in FIG. 5 (by way of example only), if the mobile device 10 is determined to be in an environment where use may be unsafe or undesirable. For example, block 203 may direct the mobile device processor 100 to only display the lock-out display 340 shown in FIG. 5 when motion above a threshold speed is detected, and to provide access to the functionality of the mobile device 10, if motion is detected that is below the threshold speed. In various embodiments, the mobile device 10 may be configured to only deny access to functionality on the mobile device 10 when the mobile device 10 is moving above the threshold speed, which may allow a user of the mobile device 10 quick access to the device when the user is not in a moving vehicle (or not in a vehicle moving in excess of the speed threshold) and therefore use by the user is not unsafe or undesirable. In other embodiments, if the mobile device 10 is detected as being in a vehicle, then access may be denied even if the vehicle is stationary or below the threshold speed unless and until passenger-related actions with the mobile device 10 are detected for added safety. Referring to FIG. 6, a flowchart 260 is shown depicting blocks of code which may be included in the block 203 shown in FIG. 4, in accordance with some embodiments.

The flowchart 260 shown in FIG. 6 begins with block 262 which directs the mobile device processor 100 shown in FIG. 3 to receive speed information representing speed of the mobile device 10. In some embodiments, block 262 may direct the mobile device processor 100 to query the GPS receiver 116 via the interface 129 and/or to query the accelerometer 107 via the interface 120 to receive information that may be used to determine speed information. For example, in some embodiments, block 262 may direct the mobile device processor 100 to receive accelerometer information from the accelerometer 107 and to use integration methods to determine the speed information from accelerometer readings received from the accelerometer 107. Accordingly, in some embodiments, the accelerometer information may represent a speed of the mobile device and may act as the speed information.

In some embodiments, block 262 may direct the mobile device processor 100 to receive location information from the GPS receiver 116 via the interface 129 and to determine the speed information from changes in the location information and so in some embodiments, the location information may represent a speed of the mobile device 10 and may act as the speed information.

In some embodiments, block 262 of the flowchart 260 shown in FIG. 6 may direct the selective access application defined by the block of codes 160 shown in FIG. 3 to use one or more application programming interfaces (“APIs”) defined by the operating system in the block of codes 158 to determine the speed information. For example, in some embodiments, the mobile device 10 may be an Apple™ product such as an iPhone™ running iOS™ and block 262 may direct the selective access application to use CoreLocation APIs and/or CoreMotion APIs of the operating system to determine the speed information. In some embodiments, the speed information may be determined and stored in memory, such as temporary memory in the storage memory 104, for example, by the operating system of the mobile device 10 and block 262 may direct the mobile device processor 100 to retrieve or receive the speed information from memory.

Referring to FIG. 6, in some embodiments, block 262 may direct the mobile device processor 100 shown in FIG. 3 to receive a speed record 280 as shown in FIG. 7 via the operating system APIs. The speed record 280 includes a speed field 282 for storing a value representing a speed of the mobile device 10. In the embodiment shown in FIG. 7, the speed field 282 stores a value of 5 (by way of example only, representing a speed at the time of a sampling), which indicates that the mobile device 10 is traveling at 5 m/s. Block 262 may direct the selective access application to store a representation of the speed record 280 in the location 140 of the storage memory 104.

Referring to FIG. 6, block 264 directs the mobile device processor 100 shown in FIG. 3 to determine whether the speed represented by the speed information is greater than a threshold speed. In some embodiments, the threshold speed may be set to a speed above which, it is reasonable to assume that the mobile device is in a moving vehicle. For example, in some embodiments, the threshold speed may be a speed that is greater than a predetermined walking speed, such as, for example, about 1 or 2 m/s (or some speed in between about 1 and 2 m/s).

In other embodiments the threshold speed may be a speed that is greater than a predetermined jogging or running speed, such as, about 3, 4 or 5 m/s or more, for example (or some speed in between about 3 and 5 m/s). In other embodiments, the threshold speed may be below about 1 m/s.

In one embodiment, the mobile device 10 may be configured to apply a threshold speed of 2.0 m/s and block 264 may direct the mobile device processor 100 to retrieve the speed record 280 from the location 140 of the storage memory 104 and to compare the value stored in the speed field 282 of the speed record to the threshold speed of 2.0 m/s.

If at block 264, the mobile device processor 100 determines that the speed information represents a speed that is greater than the threshold speed, block 264 directs the mobile device processor 100 to proceed to block 266 and cause access to the functionality of the mobile device 10 to be denied before continuing on to block 204 of the flowchart 200 shown in FIG. 4. If at block 264, the mobile device processor 100 determines that the speed information represents a speed that is not greater than the threshold speed, block 264 directs the mobile device processor 100 to proceed to block 268, which directs the mobile device processor 100 to cause the user to be provided access to the functionality of the mobile device 10.

In various embodiments, block 268 may direct the mobile device processor 100 to stop executing the flowchart 200 and to cause or facilitate the operating system of the mobile device 10 to display a user interface for accessing functionality of the mobile device 10, such as for example, a home screen.

In various embodiments, block 266 may direct the mobile device processor 100 to cause the display 108 to display a lock-out condition such as, by way of example, the lock-out display 340 shown in FIG. 5. In some embodiments, block 266 may direct the mobile device processor 100 to produce and transmit signals via the interface 122 shown in FIG. 3 to cause the display 108 to display the lock-out display 340. In various embodiments, where the mobile device processor 100 is described as causing the display 108 to display an element or producing signals for causing the display 108 to display an element, it may be understood that the mobile device processor 100 communicates with the display 108, for example, by producing or transmitting signals via the interface 122 shown in FIG. 3 to cause the display 108 to display the element.

Referring back to FIG. 4, block 204 directs the mobile device processor 100 to monitor for and receive representations of one or more actions taken by the user with the mobile device 10. In some embodiments, the representations of the one or more actions taken by the user may be produced by one or more sensors of the mobile device 10 shown in FIG. 3, such as, for example, the accelerometer 107, gyroscope 109, magnetometer, barometer 113, and/or display 108, and block 204 may direct the mobile device processor 100 to receive the representations via the I/O interface 106 from the sensors.

In some embodiments, block 204 may direct the mobile device processor 100 to cause the display 108 to display instructions to the user, said instructions prompting the user to take one or more passenger-related actions that if taken by the user and detected by the mobile device 10 would indicate that the user is not operating or driving the vehicle. In various embodiments, the one or more actions taken by the user may be taken in response to viewing the instructions displayed on display 108. In some embodiments, the instructions may be automated verbal instructions communicated via a speaker on or in communication with the mobile device 10. In some embodiments, the user may have previously been informed at least in part regarding what actions need to be taken to show that the user is not an operator or driver of the vehicle and to be provided access to the functionality of the mobile device 10.

Block 206 directs the mobile device processor 100 to determine whether the one or more actions taken by the user correspond to one or more passenger-related actions that if taken by the user would indicate that the user is not operating the vehicle. In some embodiments, block 206 may direct the mobile device processor 100 to determine whether the actions correspond to passenger-related actions by applying at least one passenger-related action criterion to the representations detected by the mobile device 10 of the one or more actions taken by the user with the mobile device 10.

If the at least one passenger-related action criterion is met by the representations of the one or more actions, block 206 directs the mobile device processor 100 to proceed to block 208 whereby access to the functionality of the mobile device is provided. In some embodiments, block 206 may direct the mobile device processor 100 to designate the user as a passenger before proceeding to block 208. In some embodiments, if the at least one passenger-related action criterion is not met by the representations of the one or more actions taken by the user, block 206 directs the mobile device processor 100 to return to block 204 and continue to receive updated representations representing further actions taken by the user. Accordingly, in various embodiments, the mobile device 10 may be configured such that only when the one or more actions correspond to the one or more passenger-related actions does the process continue at block 208 to provide access to the functionality of the mobile device.

In various embodiments, portions of blocks 204 and 206 may be executed concurrently and/or alternatingly.

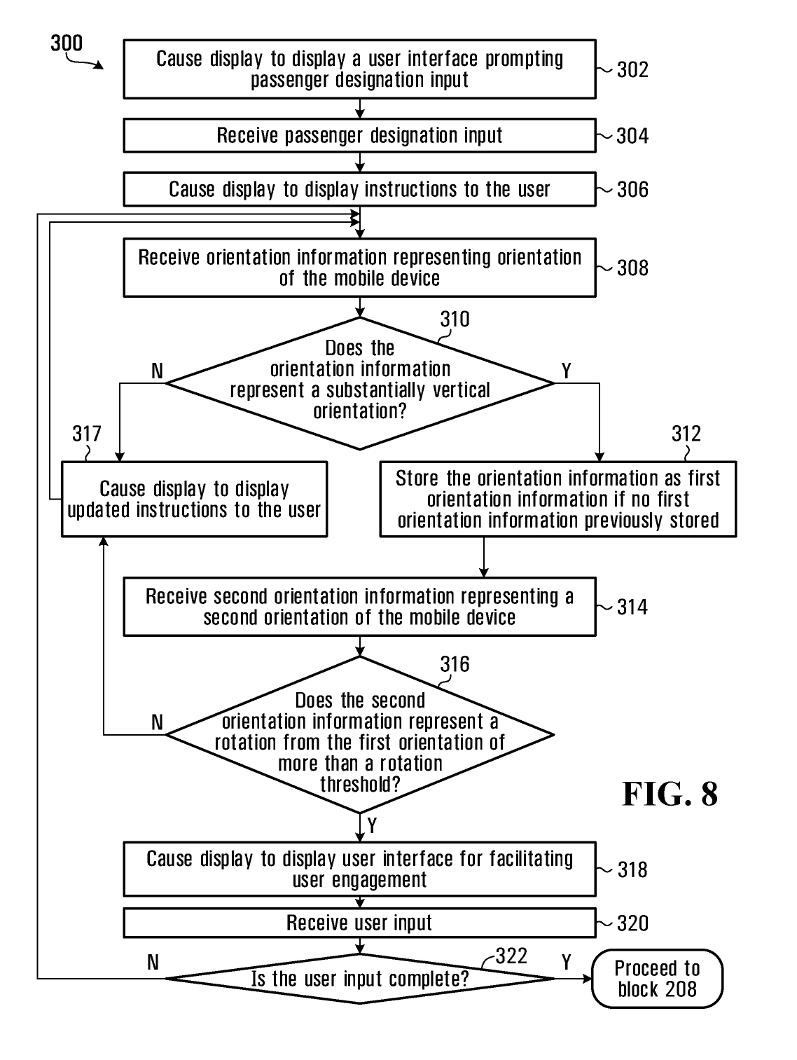

Referring to FIG. 8, there is shown a flowchart 300 depicting blocks of codes for execution by the mobile device processor 100 that may be included in the blocks 204 and 206 in accordance with various embodiments.

The flowchart 300 shown in FIG. 8 begins with block 302 which directs the mobile device processor 100 shown in FIG. 3 to cause the display 108 to display a user interface prompting passenger designation or identification input. In some embodiments, block 302 may direct the mobile device processor 100 to produce and transmit signals via the interface 122 shown in FIG. 3 to cause the display 108 to display the lock-out display 340 shown in FIG. 5 which may act as a user interface and includes a passenger designation element 342 for selection by the user of the mobile device 10 to indicate that the user wishes to identify or designate themselves as a passenger of a vehicle.

Block 304 then directs the mobile device processor 100 to receive passenger designation input. Block 304 may direct the mobile device processor 100 to monitor touchscreen input at the display 108 via the interface 122 for selection by the user of the passenger designation element 342 shown in FIG. 5. A user may select the passenger designation element 342 to cause signals representing the selection to be sent by the display 108 to the mobile device processor 100 via the interface 122 shown in FIG. 3. In FIG. 5 the passenger designation element 342 is displayed near the bottom of the display 108 for illustration purposes. However, in various embodiments the passenger designation element 342 may be displayed in any other location on the display 108 for user selection. Block 304 may direct the mobile device processor 100 to receive the signals representing user selection of the passenger designation element 342, the selection acting as passenger designation input. In response to receiving the passenger designation input at block 304, block 304 directs the mobile device processor 100 to proceed to block 306.

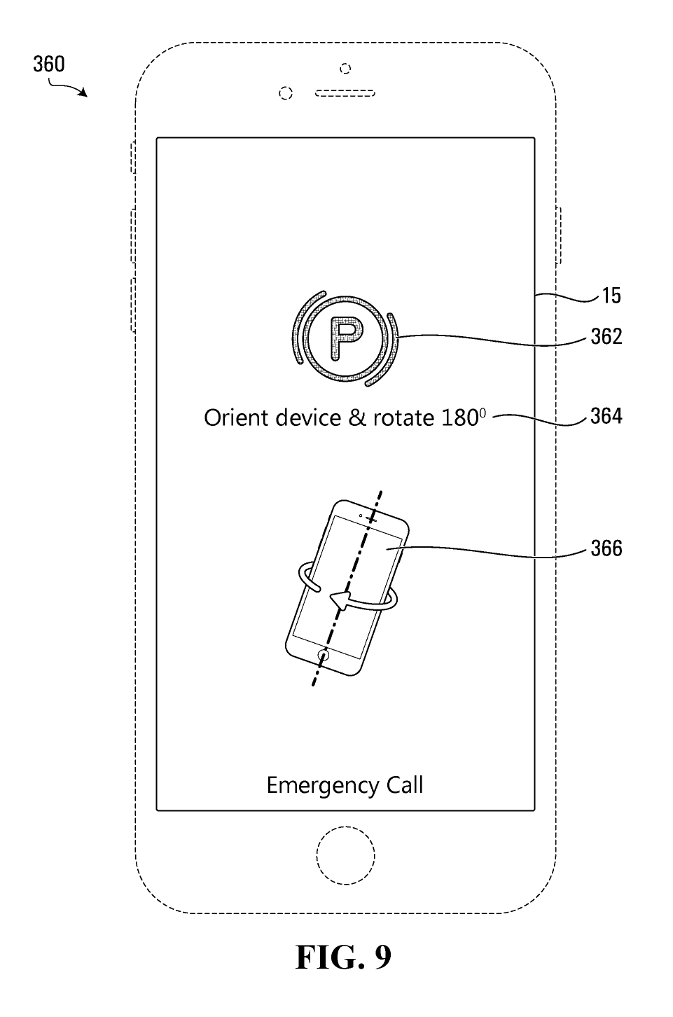

Block 306 directs the mobile device processor 100 to cause the display 108 to display instructions to the user. Block 306 directs the mobile device processor 100 to cause the display 108 to display an instructions display, such as, for example as shown generally at 360 in FIG. 9. In the embodiment shown, the instructions display 360 may include a feedback element 362, a text element 364, and a visual element 366, which act as instructions directing the user 16 to orient the device generally vertically and then rotate the mobile device about 180 degrees.

Upon viewing the instructions display 360 shown in FIG. 9, the user 16 may orient the mobile device 10 generally vertically in front of the user.

While the user 16 is orienting the mobile device 10 in accordance with the instructions display, block 308 may direct the mobile device processor 100 to receive orientation information representing an orientation of the mobile device 10. In some embodiments, block 308 may direct the mobile device processor 100 to query the accelerometer 107, gyroscope 109 and/or the magnetometer 111 via the interfaces 120, 121, and/or 123 shown in FIG. 3 and block 308 may direct the mobile device processor 100 to receive the orientation information from the accelerometer 107, gyroscope 109 and/or the magnetometer 111 via the interfaces 120, 121, and/or 123.

In some embodiments, block 308 may direct the selective access application defined by the block of codes 160 to use one or more APIs defined by the operating system in the block of codes 158 to determine the orientation information. The operating system may use information received from the accelerometer 107, gyroscope 109 and/or the magnetometer 111 to determine the orientation information representing information as to the orientation and rotation of the mobile device 10. In various embodiments, the orientation information may act as access configuration information. For example, in some embodiments, the mobile device 10 may be running the iOS™ operating system and block 308 may direct the selective access application to use the CoreMotion API of the operating system to determine the orientation information/access configuration information. Upon a first execution of block 308, block 308 may direct the selective access application to register for CoreMotion updates, for example. In some embodiments, the orientation information/access configuration information may be determined and stored in memory, such as temporary memory, for example, by the operating system of the mobile device 10 and block 308 may direct the mobile device processor 100 to retrieve or receive the orientation information/access configuration information from memory.

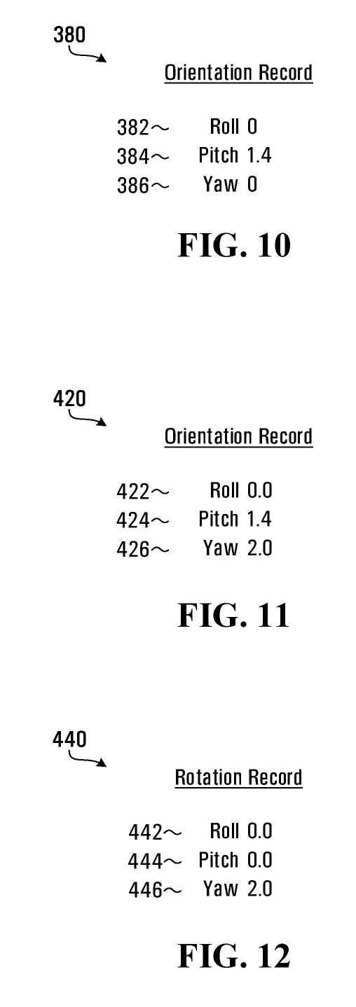

In some embodiments, block 308 may direct the mobile device processor 100 to receive an orientation record 380 as shown in FIG. 10, such as, for example, via the operating system APIs. The orientation record 380 includes a roll field 382 for storing a value representing a roll orientation of the mobile device 10, a pitch field 384 for storing a value representing a pitch orientation of the mobile device 10, and a yaw field 386 for storing a value representing a yaw orientation of the mobile device 10.

In various embodiments, the roll, pitch and/or yaw fields 382, 384, and 386 and/or combinations thereof may include values which represent in radians one or more angles of orientation or rotation of the mobile device 10. In some embodiments, the mobile device 10 may be in a neutral position when the mobile device 10 is placed generally flat on a table, with the display facing up, and each of the roll, pitch, and yaw fields 382, 384, and 386 may be set to 0 when the mobile device is in the neutral position.

Block 308 may direct the mobile device processor 100 to store the orientation record 380 as orientation information/access configuration information in the location 142 of the storage memory 104 shown in FIG. 3.

Referring back to FIG. 8, block 310 directs the mobile device processor 100 shown in FIG. 3 to determine whether the orientation information/access configuration information represents a substantially or generally vertical orientation. Block 310 may direct the mobile device processor 100 to retrieve the received orientation information/access configuration information from the location 142 of the storage memory and to apply at least one verticality criterion to the orientation information/access configuration information to determine whether the orientation information/access configuration information represents an orientation that is substantially vertical.

If it is determined that the orientation information/access configuration information does not represent a substantially vertical orientation, block 310 directs the mobile device processor 100 to proceed to block 317 to update the instructions displayed to the user and then return to block 308 to update the orientation information/access configuration information. When it is determined that the orientation information/access configuration information represents a substantially vertical orientation, block 310 directs the mobile device processor 100 to proceed to block 312.

In some embodiments, when the pitch field 384 of the orientation record 380 shown in FIG. 10 is at a value of pi/2 radians (i.e., about 1.57 radians) representing an angle of about 90 degrees, it may be considered that the mobile device 10 is in a substantially vertical orientation wherein the display 108 of the mobile device 10 is in a substantially vertical plane.

In some embodiments, the mobile device 10 may be considered to be substantially vertical when the orientation information/access configuration information represents an orientation of the mobile device 10 that is within a threshold angle of the vertical orientation. In some embodiments, the threshold angle may be about 15 degrees, for example. In other embodiments, the threshold angle may be less than about 15 degrees. In other embodiments, for a less tolerant approach to assessing whether the mobile device 10 has a substantially vertical orientation, the threshold angle may be about 5 degrees or less. The lower the threshold angle, the closer the mobile device 10 will need to be oriented to a true vertical orientation by the user in order to be substantially vertical.

Referring to FIG. 8, in some embodiments, block 310 may direct the mobile device processor 100 to retrieve the orientation record 380 from the storage memory 104 shown in FIG. 3 and to apply at least one verticality criterion to the orientation record 380 to determine whether the mobile device is within a threshold angle of the vertical orientation. In some embodiments, block 310 may direct the mobile device processor 100 to determine whether the pitch stored in the pitch field 384 of the orientation record is greater than about 1.3 radians (about 75 degrees). If at block 310, the mobile device processor 100 determines that the value stored in the pitch field 384 is greater than 1.3 radians, block 310 may direct the mobile device processor 100 to determine that the orientation information/access configuration information represents a substantially vertical orientation.

In some embodiments, block 310 may direct the mobile device processor 100 to apply additional criteria to the orientation information and determine whether the orientation information represents a desired orientation by comparing the orientation represented by the orientation information to a direction of travel of the vehicle 14. For example, in some embodiments, the desired orientation may be one where the display 108 of the mobile device 10 is substantially vertical and in front of a user, facing towards the user and towards a rear portion of the vehicle 14. Block 310 may direct the mobile device processor 100 to make this determination by determining whether the orientation information represents an orientation wherein the display 108 faces a direction substantially opposite to a direction of movement or heading of the mobile device 10 and therefore opposite to a direction of movement or heading of the vehicle 14.

Accordingly, block 310 may direct the mobile device processor 100 to receive or determine a heading for the mobile device 10. In some embodiments, block 310 may direct the selective access application to use device location and motion features available from the operating system (e.g. CoreLocation APIs and/or CoreMotion APIs of the operating system) to determine the heading. Block 310 may direct the mobile device processor 100 to determine whether the orientation represented by the orientation information corresponds to one in which the display 108 faces a direction opposite to the heading. Block 310 may direct the mobile device processor 100 to proceed to block 312 only if the orientation represented by the orientation information corresponds to one in which the mobile device 10 is substantially vertical and the display 108 faces a direction substantially or generally opposite to the heading.

In some embodiments, when block 310 has previously been answered in the affirmative and orientation information is stored in the location 144 of the storage memory 104 as first orientation information, block 310 may only require that the mobile device 10 be substantially vertical, and not require that the display 108 be facing a direction opposite to the direction of movement of the vehicle 14.

Accordingly, in some embodiments, block 310 may direct the mobile device processor 100 to determine whether orientation information is stored in the location 144 of the storage memory 104 as first orientation information and block 310 may direct the mobile device processor 100 to, if orientation information is stored in the location 144, not apply the additional heading based criteria to determine whether the orientation information represents an orientation wherein the display 108 faces a direction substantially opposite to a direction of movement of the mobile device 10.

Referring to FIG. 8, block 312 directs the mobile device processor 100 shown in FIG. 3 to store the orientation information/access configuration information as first orientation information/access configuration information if no first orientation information/access configuration information has been previously stored. Block 312 may direct the mobile device processor 100 to read the location 144 of the storage memory 104 and determine whether the location 144 stores a first orientation record. If the location 144 does not store a first orientation record, block 312 directs the mobile device processor 100 to store the orientation record 380 in the location 144 as a first orientation record. If at block 312 it is determined that the location 144 already stores a first orientation record, block 312 directs the mobile device processor 100 to proceed to block 314.

Referring to FIG. 8, block 314 directs the mobile device processor 100 to receive second orientation information/access configuration information representing a second orientation of the mobile device. In some embodiments, the second orientation information/access configuration information may be received generally as described above having regard to block 308. In some embodiments, block 314 may direct the mobile device processor 100 to receive a second orientation record 420 as shown in FIG. 11 including roll pitch and yaw fields 422, 424, and 426 and block 314 may direct the mobile device processor 100 to store the second orientation record 420 in the location 142 of the storage memory 104 as updated orientation information/access configuration information.

Block 316 then directs the mobile device processor 100 to determine whether the second orientation information/access configuration information represents a rotation from the first orientation represented by the first orientation information/access configuration information of more than a rotation threshold. In some embodiments, block 316 may direct the mobile device processor 100 to determine a rotation from the first orientation to the second orientation by applying to or multiplying a matrix representation of the second orientation record 420 shown in FIG. 11 by one or more inverse matrix representations of the orientation record 380 shown in FIG. 10 stored as the first orientation record. For example, in some embodiments, block 316 may direct the mobile device processor 100 to use APIs of the operating system to make one or more calls to the operating system to determine the rotation required to go from the first orientation to the second orientation.

Block 316 may direct the mobile device processor 100 to store a representation of the rotation vector as a rotation record 440 as shown in FIG. 12 in the location 146 of the storage memory 104. Referring to FIG. 12, the rotation record 440 includes a roll field 442, a pitch field 444, and a yaw field 446 for storing respective changes or rotations in roll, pitch, and yaw required to rotate from the first orientation to the second orientation. Block 316 may direct the mobile device processor 100 to determine a magnitude associated with the rotation record 440 by determining the square root of the sum of the squares of each of the roll, pitch, and yaw values. Block 316 may direct the mobile device processor 100 to compare the magnitude to a threshold rotation magnitude to determine whether the rotation is greater than the rotation threshold.

In some embodiments, the threshold rotation magnitude may be about 1.8 radians (i.e., about 100 degrees) and block 316 may direct the mobile device processor 100 to determine whether the magnitude of the rotation record 440 is greater than about 1.8. If at block 316, the mobile device processor 100 determines that the magnitude of the rotation record 440 is greater than about 1.8, block 316 directs the mobile device processor 100 to proceed to block 318. If not, block 316 directs the mobile device processor 100 to proceed to block 317. In various embodiments, the threshold rotation magnitude may be chosen such that rotation of the mobile device 10 greater than the threshold rotation magnitude would be difficult, unsafe, or impossible for an operator of the vehicle 14 to perform with the mobile device 10. In various embodiments, the threshold rotation magnitude may be chosen such that when the mobile device 10 has been rotated more than the threshold rotation magnitude, an operator of the vehicle 14 may find it difficult, unsafe, or impossible to view the display of the mobile device 10 (e.g. touchscreen display 15 in FIG. 5) and/or provide input using the user interface 16 displayed on the mobile device 10 while operating the vehicle 14 as the driver. In various embodiments, the threshold rotation magnitude may be chosen such that when the mobile device 10 has been rotated more than the threshold rotation magnitude by a user of the mobile device 10, steering or driving the vehicle 14 would be difficult, unsafe, or impossible if the user is the operator of the vehicle 14. For example, in some embodiments, the threshold rotation magnitude may represent a rotation of between about 90 degrees and about 180 degrees.

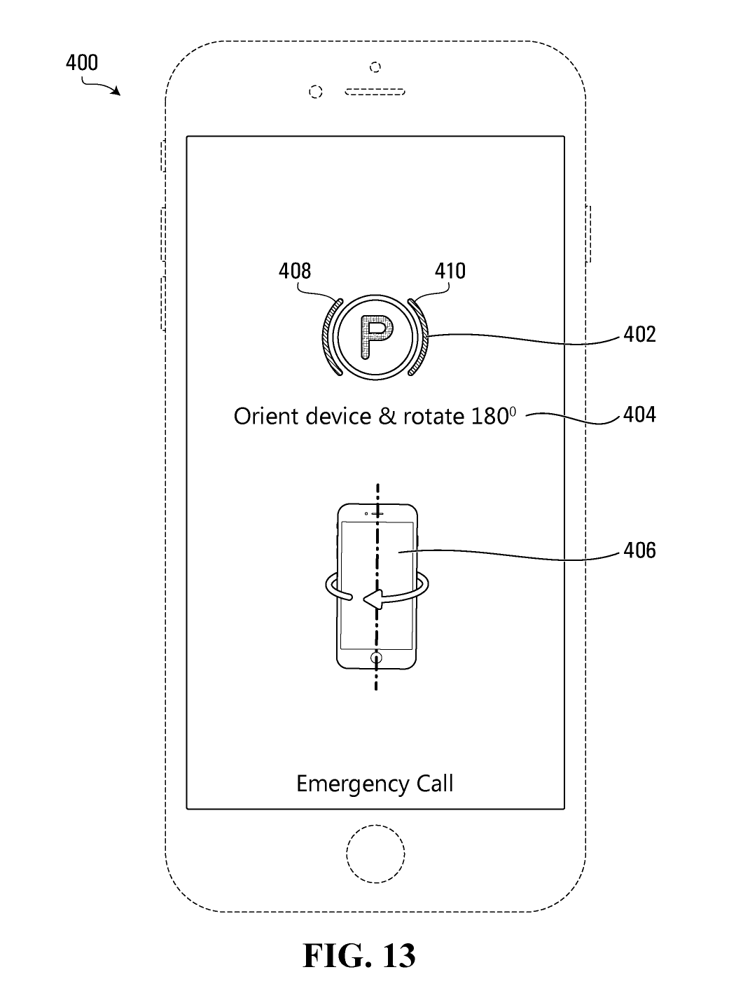

Referring to FIG. 8, block 317 directs the mobile device processor 100 to cause the display 108 to display updated instructions to the user. In some embodiments, block 317 may direct the mobile device processor 100 to produce signals for causing the display 108 to display an updated instructions display 400 as shown in FIG. 13. The updated instructions display 400 may include an updated feedback element 402, a text element 404, and an updated visual element 406. In various embodiments, the updated feedback element 402 and/or the updated visual element 406 may include dynamic indicia displayed to indicate to a user a present sensed orientation of the mobile device 10. The dynamic indicia may indicate to the user how close the mobile device 10 may be to a substantially vertical orientation and how and whether to change the orientation to reach the substantially vertical orientation. In some embodiments, if for example, the mobile device processor 100 proceeds to block 317 from block 316 and the orientation information received represents a substantially vertical orientation, block 317 may direct the mobile device processor 100 to cause the display (e.g. touchscreen display 15) to display an indication that the mobile device 10 is substantially vertical and should now be rotated.

Referring to FIG. 13, in the embodiment shown, the updated feedback element 402 is shown when the updated orientation data stored in the location 142 of the storage memory 104 represents a substantially vertical orientation. The updated feedback element 402 shown in FIG. 13 includes color indicia with elements 408 and 410 set to green instead of yellow as shown in the instructions display 360 shown in FIG. 9 and oriented generally vertically and the updated visual element 406 depicts the mobile device vertically rather than at an angle. The updated feedback element 402 as shown in FIG. 13 may indicate to the user that the mobile device 10 is substantially vertical and that the user should proceed to rotate the device.

In some embodiments, updated instructions may be difficult to view and/or follow by an operator or driver of the vehicle 14 whereas they may be easy to view and follow by a passenger and so the updated instructions displayed to the user may facilitate a passenger user being able take the actions but discourage an operator or driver of the vehicle 14 from attempting to take the actions. In response to viewing the updated instructions, the user may continue with taking the one or more actions, in accordance with the instructions.

In some embodiments, when block 317 is executed in response to a negative determination at block 310, block 317 may direct the mobile device processor 100 to delete the first orientation information/access configuration information stored in the location 144 of the storage memory 104 or set the first orientation information/access configuration information stored in the location 144 to a null value, such that the first orientation information/access configuration information will be updated the next time that block 312 is executed.

Referring back to block 316 of FIG. 8, as discussed above, if the magnitude of the rotation record 440 represents a rotation of more than the rotation threshold, block 316 directs the mobile device processor 100 to proceed to block 318. For example, the magnitude of the rotation record 440 shown in FIG. 12 may be determined to be 2.0 which is greater than 1.8 and so block 316 may direct the mobile device processor 100 to proceed to block 318 if the rotation record 440 was determined and stored at block 316.

In some embodiments, rotation of the mobile device 10 more than the rotation threshold may result in the mobile device being in an orientation that cannot be viewed or is difficult to view while operating the vehicle 14. Accordingly, once the mobile device processor 100 is directed to block 318 in some embodiments, it may be assumed that an operator or driver of the vehicle would not be able to view or focus on the display 108 while operating the vehicle.

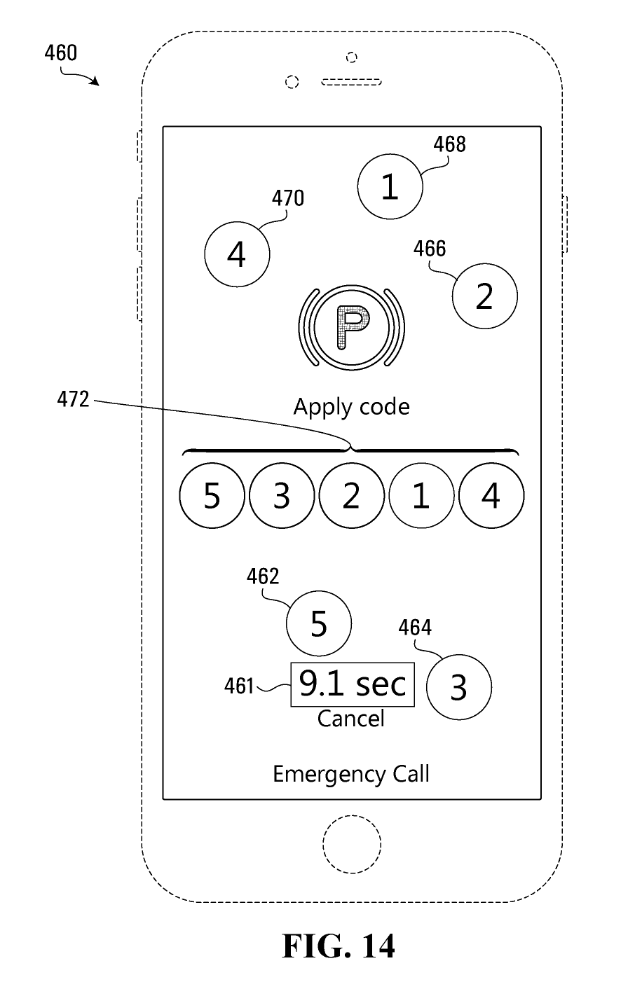

Referring to FIG. 8, block 318 directs the mobile device processor 100 shown in FIG. 3 to cause the display to display a user interface for facilitating user engagement. In some embodiments, block 318 may direct the mobile device processor 100 to produce signals for causing the display 108 to display a user interface 460 as shown in FIG. 14. The user interface 460 may include moving elements 462, 464, 466, 468, and 470, which a user may touch on the display 108 in order to apply a code. In some embodiments, for example, the moving elements 462-470 may move on paths which appear to bounce or reflect off of edges of the display. In some embodiments, by requiring the user to interact with the moving elements 462-470, the user may need to view or focus on the display 108 continuously for an extended period of time, in order to correctly enter the code. This requirement may discourage a user who is an operator of a vehicle from attempting to interact with the user interface 460 and apply the code.

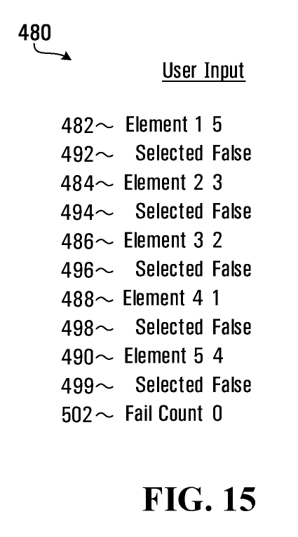

In some embodiments, block 318 of the flowchart 300 shown in FIG. 8 may direct the mobile device processor 100 to generate random values for each of the moving elements 462, 464, 466, 468, and 470 and to store the values in a user input record 480 as shown in FIG. 15 in the location 148 of the storage memory 104. Referring to FIG. 15, the user input record 480 includes first, second, third, fourth, and fifth element value fields 482, 484, 486, 488 and 490 for storing values to be displayed with the respective moving elements 462, 464, 466, 468, and 470 of the user interface 460 shown in FIG. 14. The user input record 480 also includes selected element fields 492, 494, 496, 498, and 499 for storing Boolean values representing whether the moving element associated with the respective element value fields 482, 484, 486, 488 and 490 have been selected by a user. The selected element fields 492, 494, 496, 498, and 499 may each be initialized to a value of False to indicate that the elements have not been selected.

In some embodiments, the user input record 480 may also include a fail count field 502 for storing a count of the number of times the user 16 has failed at interacting with the user interface or inputting the code. Upon a first execution of block 318, block 318 may direct the mobile device processor 100 to initialize the fail count field 502 to store a value of 0.

In some embodiments, the user may have a limited amount of time for providing the user input. The mobile device 10 may be configured to, once the time for providing input has passed, return to block 306, for example. In some embodiments, block 318 may direct the mobile device processor 100 to start a timer for determining a user input time period during which the user interface has been displayed by the display 108 without interruption by execution of block 317. Block 318 may direct the mobile device processor 100 to determine whether the user input time period is greater than an input threshold time and if the user input time is greater than the input threshold time, block 318 may direct the mobile device processor 100 to reset the user input record 480, to delete the first orientation information/access configuration information stored in the location 144 of the storage memory 104 or set the first orientation information/access configuration information stored in the location 144 to a null value, and to return to block 306. In some embodiments, the input threshold time may be predetermined and set to a time which would allow the user 16 to complete the user input, if the user were to provide substantially all of their attention to the user interface, but would make it difficult or impossible for the user 16 to complete the user input if the user were distracted or not continuously interacting with the user interface. In some embodiments, for the user interface 460 shown in FIG. 14 the input threshold time may be about 15 seconds, for example.

Referring to FIG. 8, block 320 directs the mobile device processor 100 shown in FIG. 3 to receive user input. In various embodiments, block 320 may direct the mobile device processor 100 to receive user input from the display 108 via the interface 122 shown in FIG. 3. Block 320 may direct the mobile device processor 100 to update the user input record 480 as shown in FIG. 15 to reflect the received input. In some embodiments, when the user input represents a selection of a moving element, block 320 may direct the mobile device processor 100 to cause a selected element field associated with the moving element to be set to True. Block 318 may direct the mobile device processor 100 to not display a moving element when the moving element is associated with a selected element field having a value of True.

In some embodiments, block 320 may direct the mobile device processor 100 to require that the moving elements 462, 464, 466, 468, and 470 be selected in order, for example, as indicated by a stationary representation of the elements 472. Accordingly, upon receiving user input representing selection of a moving element, block 320 may direct the mobile device processor 100 to determine whether the selected moving element has been selected in order, such as, for example, by reading the user input record 480 and determining whether all selected element fields preceding the selected element field associated with the selected moving element are set to True.

If it is determined that the selected moving element was selected in order, block 320 may direct the mobile device processor 100 to update the selected element field associated with the selected moving element to store a value of True. If it is determined that the selected moving element was not selected in order, block 320 may direct the mobile device processor 100 to increment the fail count field 502 and to not update the selected element field associated with the selected moving element.

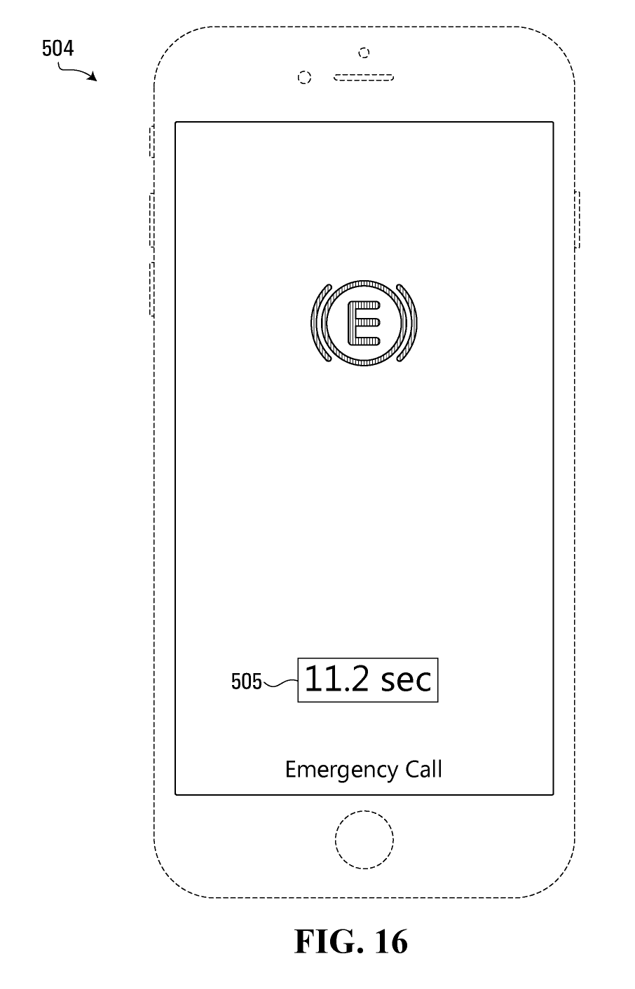

In various embodiments, block 320 may direct the mobile device processor 100 to lockout the user from the phone for a predetermined wait time period when the fail count field 502 meets a fail threshold criterion. For example, block 320 may direct the mobile device processor 100 to cause the display 108 to display a lock-out display as shown at 504 in FIG. 16 for the wait time period if the value stored in the fail count field 502 of the user input record 480 is greater than or equal to a predetermined fail threshold value. In some embodiments, the fail threshold value may be set to a value that may allow a user a reasonable number of attempts before locking the user out. For example, in some embodiments, the fail threshold value may be set to 3, such that after 3 failed inputs, the lock-out display 504 shown in FIG. 16 is displayed. In some embodiments, the wait time period may be set to a time that would be discouraging to a user who is an operator but still reasonable for a passenger to wait before reattempting to unlock the phone. For example, the wait time period may be about 15 seconds. In various embodiments, the fail threshold value and/or the wait time period may be set to other values and/or times.

In some embodiments, block 320 may direct the mobile device processor 100 to, when the fail count field 502 meets the fail threshold criterion, re-set or re-initialize the user input record 480 with new random values in the element value fields 482-490, False values in the selected element fields 492-499, and a value of 0 in the fail count field 502. In some embodiments, block 320 may direct the mobile device processor 100 to, when the fail count field 502 meets the fail threshold criterion, reset the first orientation record stored in the location 144 of the storage memory 104 to a null value.

Block 320 may direct the mobile device processor 100 to, after causing the display 108 to display the lock-out display 504 for the wait time period, continue executing and proceed to block 322 or 308 of the flowchart 300 shown in FIG. 8, for example.

In some embodiments, blocks 320 and 318 may be executed concurrently and or repeatedly to show updates to the user interface 460 as each of the moving elements 462 and 470 are selected. In some embodiments, block 318 may direct the mobile device processor 100 to read the user input record 480 from the location 148 of the storage memory 104 and to only show moving elements for elements that are associated with a selected element field having a value of False.

Block 322 then directs the mobile device processor 100 to determine whether the user input is complete. If any of the moving elements have not yet been selected by the user, then block 322 directs the mobile device processor 100 to determine that the user input is not complete and directs the mobile device processor 100 to return to block 308, to ensure that the mobile device 10 is still generally vertical at block 310 and to ensure that the mobile device 10 is still rotated by more than a rotation threshold at block 316. In some embodiments, block 322 may direct the mobile device processor 100 to determine whether all of the selected element fields 492, 494, 496, 498, and 499 are set to True. Block 322 may direct the mobile device processor 100 to determine that the user input is complete when all of the selected element fields 492, 494, 496, 498, and 499 are set to True.

In various embodiments after execution of block 318 has occurred, during the execution of blocks 308, 310, 312, 314, and 316, the user interface 460 may continue to be displayed, as long as block 317 is not executed. In various embodiments, if at either block 310 or 316 it is determined that the orientation information/access configuration information does not meet the criterion applied in these blocks and the mobile device processor 100 is directed to block 317, as described above, block 317 may direct the mobile device processor 100 to cease causing the display 108 to display the user interface 460. In some embodiments, if block 317 directs the mobile device processor 100 to cease causing the display 108 to display the user interface 460, block 317 may direct the mobile device processor 100 to increment the fail count field 502 of the user input record 480 stored in the location 148 of the storage memory 104. In various embodiments, block 317 may direct the mobile device processor 100 to lockout the user from the phone for a predetermined wait time period when the fail count field 502 meets the fail threshold criterion, for example, as described above having regard to block 320.

In some embodiments, block 317 of the flowchart 300 shown in FIG. 8 may direct the mobile device processor 100 shown in FIG. 3 to reset the selected element fields and/or the element value fields of the user input record 480 stored in the location 148 of the storage memory 104, such that the next time block 318 is executed the user is provided with a user interface that does not have any portion of code entered. In some embodiments, block 317 may direct the mobile device processor 100 to set the selected element fields 492, 494, 496, 498, and 499 to False.

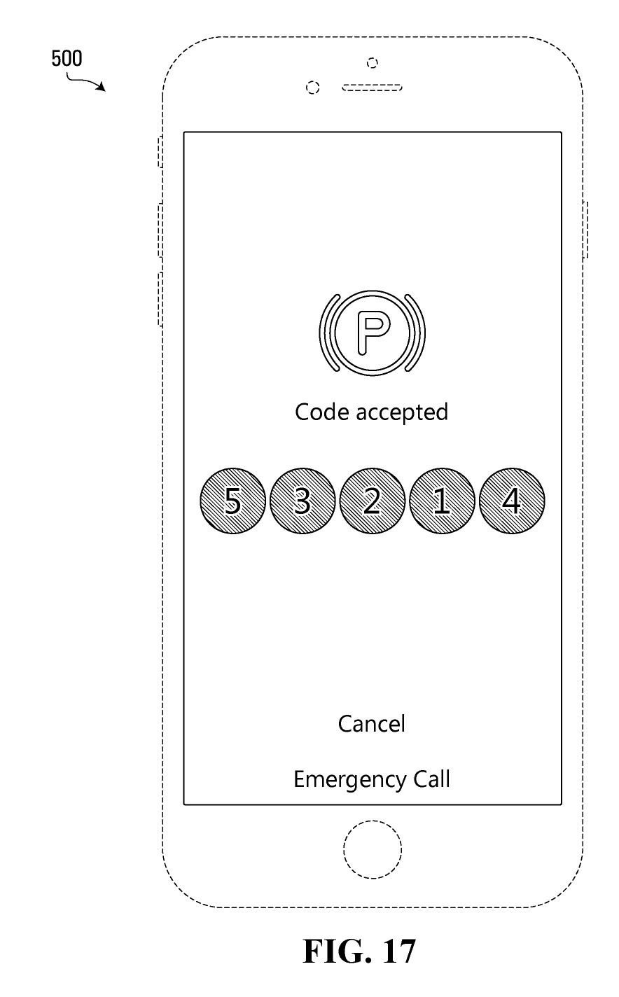

If at block 322 it is determined that the user input is complete, block 322 directs the mobile device processor 100 to proceed to block 208 of the flowchart 200 shown in FIG. 4. Such a determination at block 322 may act as a determination that actions taken by the user 16 and represented by the orientation information/access configuration information and user input received at blocks 304, 308, 316 and 318 correspond to one or more passenger-related actions that if taken by the user would indicate that the user is not operating the vehicle. In some embodiments, block 322 may direct the mobile device processor 100 to cause the display to display a code accepted display 500 as shown in FIG. 17.

In various embodiments, execution of blocks 302, 304, 306, 308, 310, 312, 317, 314, and 316 without continuing on to blocks 318, 320, and 322 may be considered to occur when the mobile device 10 is in the access pre-conditioning state. In various embodiments, execution of blocks 318, 320, and 322 of the flowchart 300 shown in FIG. 8 may occur when the mobile device 10 is in the access assessment state.

While blocks 318, 320, and 322 have been described above in accordance with some embodiments, in other embodiments, the tests or criteria applied during execution of blocks 318, 320, and 322 may vary and, in various embodiments, blocks 318, 320 and 322 or blocks generally similar to these blocks may be executed to cause the mobile device processor 100 to provide different or additional user interfaces and/or cognitive tests for the user 16 while the mobile device 10 is in the access assessment state.

For example, in some embodiments, blocks 318, 320, and 322 or blocks generally similar to blocks 318, 320, 322 may cause the mobile device 10 to provide a multi-touch test to the user wherein the user must simultaneously or substantially simultaneously touch two or more locations on the display 108 in order to complete the user input. In various embodiments, because it may be difficult or impossible for a user to touch more than one location on the display 108 while using just one hand, the multi-touch test may discourage an operator of the vehicle 14 who may wish to keep one hand in control of the vehicle, such as, for example, by keeping one hand on the steering wheel, from attempting to provide multi-touch input.

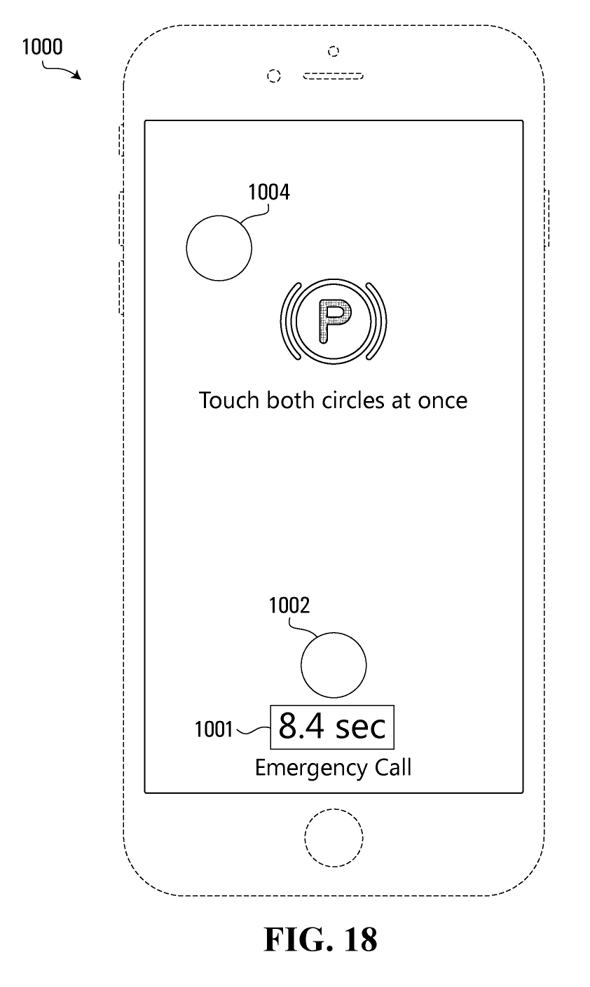

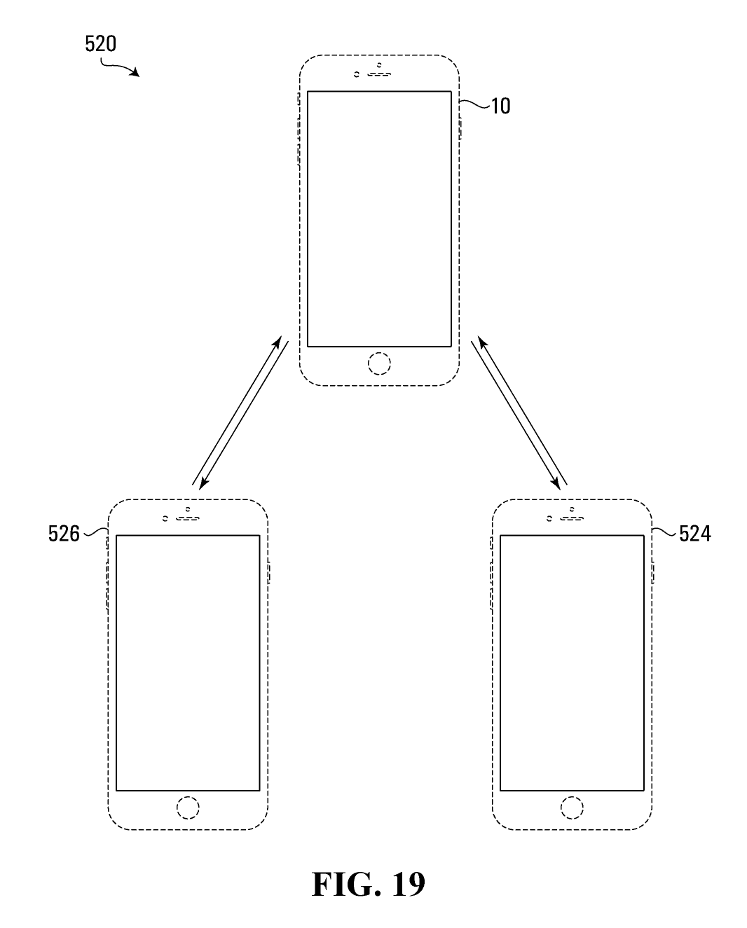

In some embodiments, block 318 of the flowchart 300 shown in FIG. 8 may direct the mobile device processor 100 shown in FIG. 3 to cause the display 108 to display a multi-touch user interface 1000 as shown in FIG. 18 including a first multi-touch element 1002 and a second multi-touch element 1004 with instructions to touch both elements at once. Block 320 may direct the mobile device processor 100 to receive touch input via the display 108 and block 322 may direct the mobile device processor 100 to determine that the input is complete when the touch input received at block 318 is representative of the user 16 touching both of the first and second multi-touch elements 1002 and 1004 simultaneously.

In some embodiments, at least one of the multi-touch elements 1002 and 1004 may appear intermittently at different locations on the display 108. For example, in some embodiments, the first multi-touch element 1002 may be stationary and the second multi-touch element 1004 may appear and disappear intermittently at various locations on the display 108. In some embodiments, the first multi-touch element 1002 may be stationary and located near a bottom of the display 108 and this may facilitate the user 16 continuously holding down on or touching the multi-touch element 1002 with a thumb of the hand that the user 16 is holding the mobile device 10 with, for example, while using their other hand which is not holding the mobile device 10 to touch the second multi-touch element 1004.

In some embodiments, the multi-touch user interface 1000 may include 5 or more multi-touch elements so that the user is forced to use two hands to complete the user input.

In some embodiments, blocks 318, 320, and 322 of the flowchart 300 shown in FIG. 8 or blocks generally similar to blocks 318, 320, 322 may cause the mobile device 10 to provide a question, such as a multiple choice question to the user and the user may be required to correctly answer the question to complete the user input. In some embodiments, block 318 or a block generally similar to block 318 may direct the mobile device processor 100 to cause the display 108 to display a question to the user 16 and the user input received at block 320 may represent the user's response to the question. In some embodiments, for example, block 318 may direct the mobile device processor 100 to cause the display 108 to display a multiple choice or True/False question with selectable elements representing possible responses by the user. In some embodiments, for example, the question may be based on a randomly retrieved or provided image and block 318 may direct the mobile device processor 100 to display the image to the user along with a question regarding the image. For example, in some embodiments, the question may ask “Are you looking at a cat?” and the image displayed may or may not display a cat. In various embodiments, other objects may be displayed and questions on such objects may be displayed. In some embodiments, the question may ask “What city are you in?” for example, and the user must provide a correct answer to complete the user input, for example, using a multiple choice selection.

In some embodiments, blocks 318, 320, and 322 or blocks generally similar to blocks 318, 320, 322 may cause the mobile device 10 to provide a unique user experience, such as a maze, for example, which the user must complete correctly to complete the user input.

In some embodiments, blocks 318, 320, and 322 or blocks generally similar to blocks 318, 320, 322 may cause the mobile device 10 to provide a game, such as, for example, a flight simulation game wherein the user must control first person flight movement using orientation of the mobile device 10, to navigate through a course or maze.

In various embodiments other challenges, games, interactions, or cognitive tests may be provided by blocks 318, 320, and 322 of the flowchart 300 shown in FIG. 8.

In various embodiments, the flowchart 300 shown in FIG. 8 depicts blocks of code that may be included in the blocks 204 and 206 shown in FIG. 4, which, as described above, may include portions that are executed concurrently and/or repeatedly for receiving and analysing various actions taken by the user. In some embodiments, blocks 302, 304, 306, 308, 314, 318 and/or 320 may be considered as included in the block 204 shown in FIG. 4. In some embodiments, blocks 310, 312, 316, and/or 322 may be considered as included in the block 206 shown in FIG. 4.

Referring back to FIG. 4, if at block 206 it is determined that the one or more actions correspond to one or more passenger-related actions that if taken by the user would indicate that the user is not operating the vehicle, block 206 directs the mobile device processor 100 to proceed to block 208. As discussed above, in some embodiments, this determination may be made at block 322 of the flowchart 300 shown in FIG. 8.

Block 208 directs the mobile device processor 100 to cause the user to be provided access to the functionality of the mobile device 10. In some embodiments, block 208 may direct the mobile device processor 100 to cease executing codes from the selective access application stored in the block of codes 160 of the program memory 102 and to execute code from the operating system application stored in the block of codes 158 to cause normal operation of the mobile device 10 to resume and to cause a default or home screen to be displayed by the display 108, for example.

In some embodiments, block 208 may direct the mobile device processor 100 to facilitate selectively providing access for users of one or more additional mobile devices included in a system such as the system 520 shown in FIG. 19, for example, as described in further detail below.

Multiple Devices

In some embodiments, the user 16 may be a first user of a plurality of users in the environment 12 and the mobile device 10 may be included in a system 520 as shown in FIG. 19 for facilitating access to the functionality of a plurality of mobile devices. For example, in some embodiments, the user 16 may be a first passenger in the vehicle 14 and there may be a second passenger 20 and an operator 22 in the vehicle 14 as shown in FIG. 20. The mobile device 10 may act as a first mobile device which is used by and associated with the user 16. The system 520 may include a second mobile device 524 shown in FIG. 19 normally used by and associated with the operator 22 of the vehicle 14 shown in FIG. 20 and a third mobile device 526 shown in FIG. 19 used by and associated with the second passenger 20 shown in FIG. 20. The system 520 may be configured to selectively facilitate access by the users to the functionality of the mobile devices 10, 524, and 526 shown in FIG. 19.

Referring to FIG. 19, in some embodiments, the mobile device 10 may be configured to receive a role designation designating a role of one of the users of the mobile devices 524 and 526. For example, in some embodiments, the user 16 may provide a role designation designating a role for the user of the second mobile device 524. In some embodiments, the user may provide a role designation that designates the user of the second mobile device as an operator of the vehicle 14.

In response to receiving the role designation, the mobile device 10 may be configured to cause one or more signals to be transmitted to the second mobile device 524 associated with the operator to cause the second mobile device 524 to deny access by the operator to functionality of the mobile device.

In some embodiments, the denial of access may involve the second mobile device 524 not providing access to the operator by not allowing the mobile device 524 to execute blocks similar to blocks 204, 206 and 208 of the flowchart 200 shown in FIG. 4. In some embodiments the denial of access may keep an operator user from attempting to do the one or more passenger-related actions to try to gain access to functionality of the second mobile device 524.

In some embodiments, the mobile device 10 may be configured to, in response to receiving the role designation, cause one or more signals to be transmitted to the third mobile device 526 associated with a user that is not designated as the operator to cause the third mobile device 526 to provide access to the user of the third mobile device to functionality of the third mobile device 526. Thus, in some embodiments, if a first passenger has already performed the passenger-related actions and provided role designations, the second passenger user may not be required to perform passenger-related actions to indicate that the user is not operating the vehicle in order to get access to the third mobile device 526.

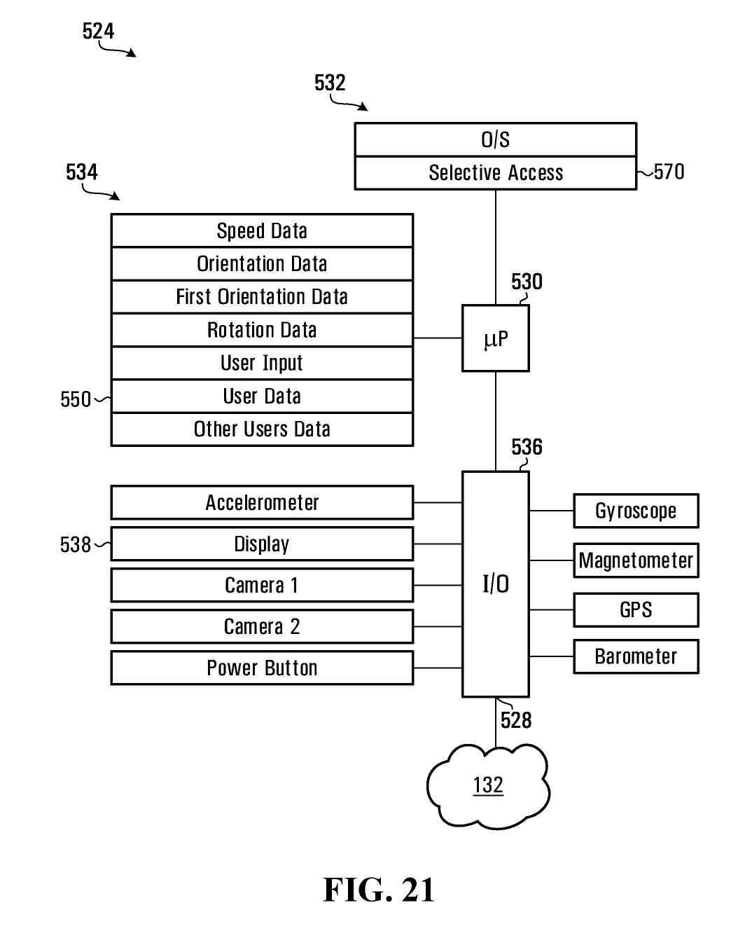

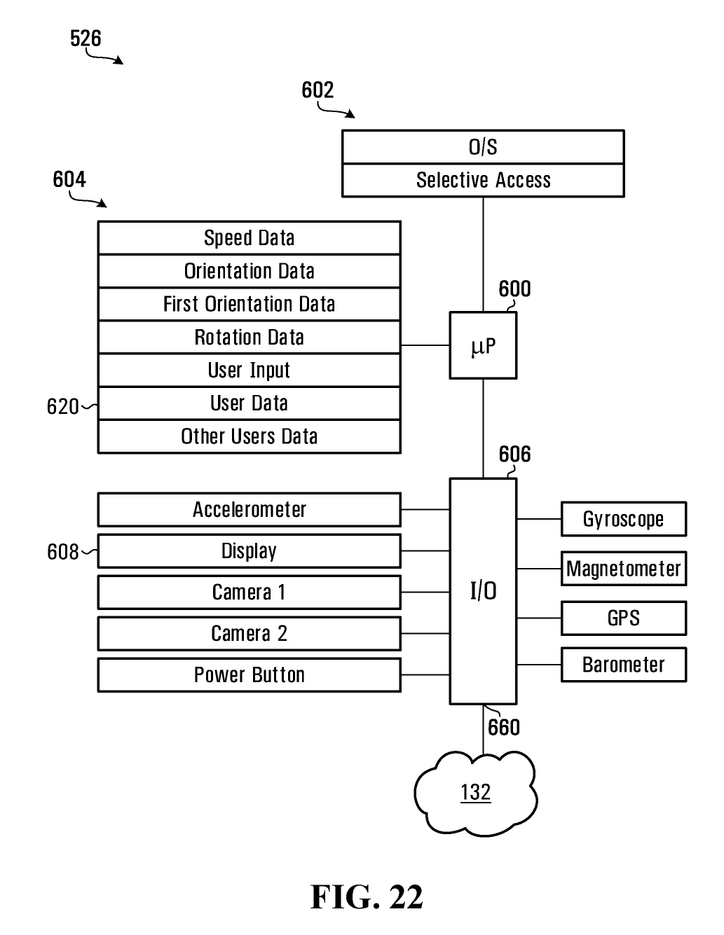

FIG. 21 shows a schematic view of a processor circuit for implementing the second mobile device 524 according to one embodiment. FIG. 22 shows a schematic view of a processor circuit for implementing the third mobile device 526 according to one embodiment. In various embodiments, each of the mobile devices 524 and 526 may include elements generally similar to the elements of the mobile device 10 shown in FIG. 3.

In some embodiments, the user 16 may use the mobile device 10 as described above to cause the mobile device processor 100 shown in FIG. 3 to execute the flowchart 200 shown in FIG. 4 and eventually cause the mobile device processor 100 to arrive at block 208 which directs the mobile device processor 100 to cause the user to be provided access to the functionality of the mobile device 10.

Referring to FIG. 23, there is shown a flowchart 700 depicting blocks of code that may be included in the block 208 shown in FIG. 4 to facilitate selectively facilitating access to functionality of mobile devices by users in accordance with one embodiment. In some embodiments, the flowchart 700 may not be executed when the mobile device 10 is the only mobile device in the vehicle 14. In some embodiments, the flowchart 700 may not be executed when there is only one mobile device other than the mobile device 10 in the vehicle 14 and it may be assumed that the other mobile device is associated with the operator of the vehicle 14. Accordingly, in some embodiments, the mobile device 10 may be configured to execute the flowchart 700 only if the mobile device 10 has previously determined that two or more mobile devices other than the mobile device 10 are in the vehicle 14. For example, in some embodiments, the mobile devices 10, 524, and 526 may be configured to communicate with one another and discover that the mobile devices 10, 524, and 526 are all in the same vehicle 14, prior to execution of the flowchart 700.

The flowchart 700 begins with block 702 which directs the mobile device processor 100 to receive a role designation associated with one of the users in the environment 12 shown in FIG. 20. In some embodiments, block 702 may direct the mobile device processor 100 to receive an operator designation representing an identification of one of the users in the environment 12 as an operator or driver of the vehicle 14.

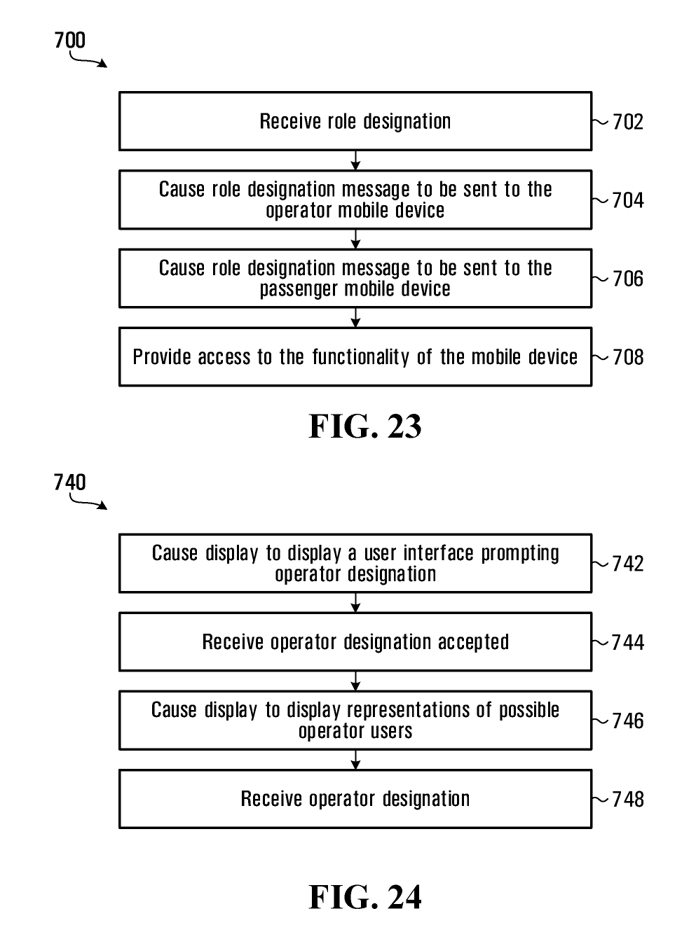

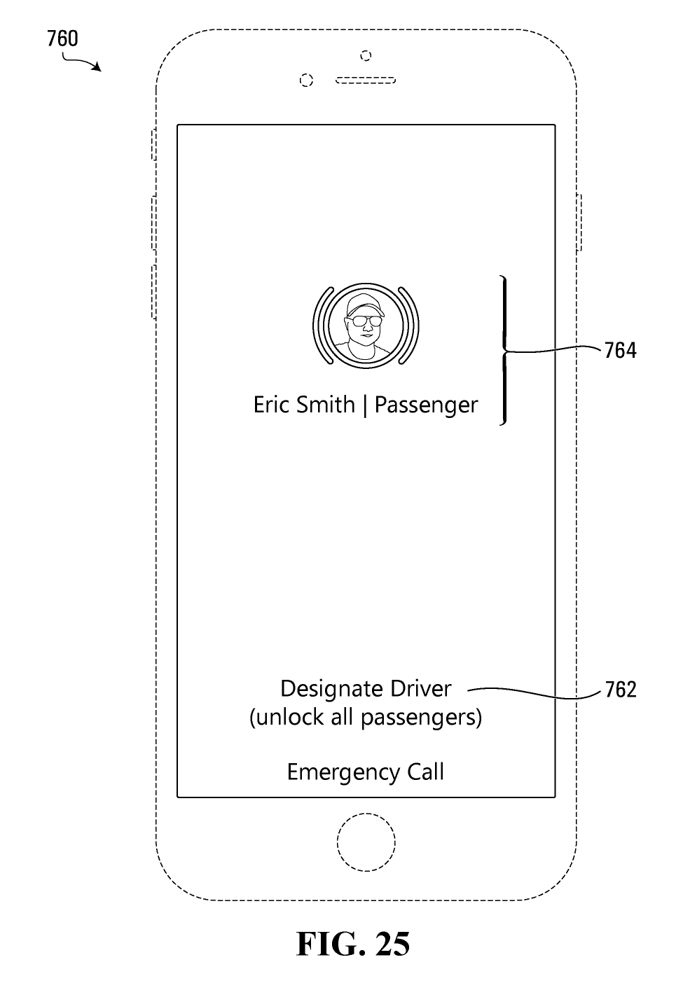

In some embodiments, block 702 may include the blocks of code included in flowchart 740 shown in FIG. 24. The flowchart 740 begins with block 742 which directs the mobile device processor 100 to cause the display 108 to display a user interface prompting operator designation. An exemplary user interface that may be displayed at block 742 is shown at 760 in FIG. 25. The user interface 760 includes an operator designation accepted element 762 for selection by a user. Selection by the user of the element 762 may indicate that the user wishes to designate another user as an operator of the vehicle 14.

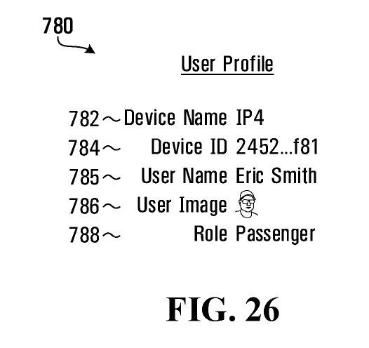

In some embodiments, the user interface 760 may include current user identification elements 764 depicting information representing the user 16 who is expected to be currently using the mobile device 10. The user 16 may have previously provided user profile information accessible to the selective access application, for example, by logging into or creating a user account, which may be represented by the current user identification elements 764 shown in FIG. 25. For example, the user 16 may have previously provided information for inclusion in a first user profile record 780 as shown in FIG. 26, which may be stored as current user profile information in the location 150 of the storage memory 104 shown in FIG. 3.

Referring to FIG. 26, the first user profile record 780 includes a device name field 782 for storing a name associated with the mobile device 10, a device identifier field 784 for storing a unique identifier (e.g. a previously generated GUID) identifying the mobile device 10, a user name field 785 for storing a user name associated with the user 16 to associate the user 16 with the mobile device 10, a user image field 786 for storing a representation of an image of the user 16 of the mobile device 10 and a role designation field 788 for storing a role designation assigned to the user 16 of the mobile device 10.

In various embodiments, the contents of the user name field 785 and the user image field 786 may have been previously provided by the user 16 and the contents of the device identifier field 784 may have been generated by the mobile device 10 during login or creation of a user account. In various embodiments, the role designation field 788 may be initially set to a null value. In various embodiments, contents of the device name field 782 may have been previously determined or retrieved by the mobile device 10 via the operating system of the mobile device 10. In some embodiments, the mobile device 10 may be configured to retrieve the contents of the device name field 782 externally from a third party profile database, such as, for example a social network database operated by a company such as Facebook™. In some embodiments, block 208 of the flowchart 200 shown in FIG. 4 may direct the mobile device processor 100 to set the role designation field 788 to “Passenger” to indicate that the user 16 is a passenger, as shown in the first user profile record 780 shown in FIG. 26, prior to executing the flowchart 700. Accordingly, in various embodiments, when block 742 is executed, the first user profile record 780 as shown in FIG. 26 may be stored in the location 150 of the storage memory 104.

Block 742 may direct the mobile device processor 100 to retrieve the user name, user image, and role from the fields 785, 786, and 788 of the first user profile record 780 stored in the location 150 of the storage memory 104 and to depict the user name, user image, and role as the current user identification elements 764 in the user interface 760 shown in FIG. 25.

Referring to FIG. 25, the user 16 may select the operator designation accepted element 762 to indicate that the user wishes to designate an operator of the vehicle 14. The selection of the operator designation accepted element may act as an operator designation accepted message. Referring to FIG. 24, block 744 directs the mobile device processor 100 to receive the operator designation accepted message via the interface 122 from the display 108 shown in FIG. 3. In response to receiving the operator designation accepted message at block 744, block 744 may direct the mobile device processor 100 to proceed to block 746.

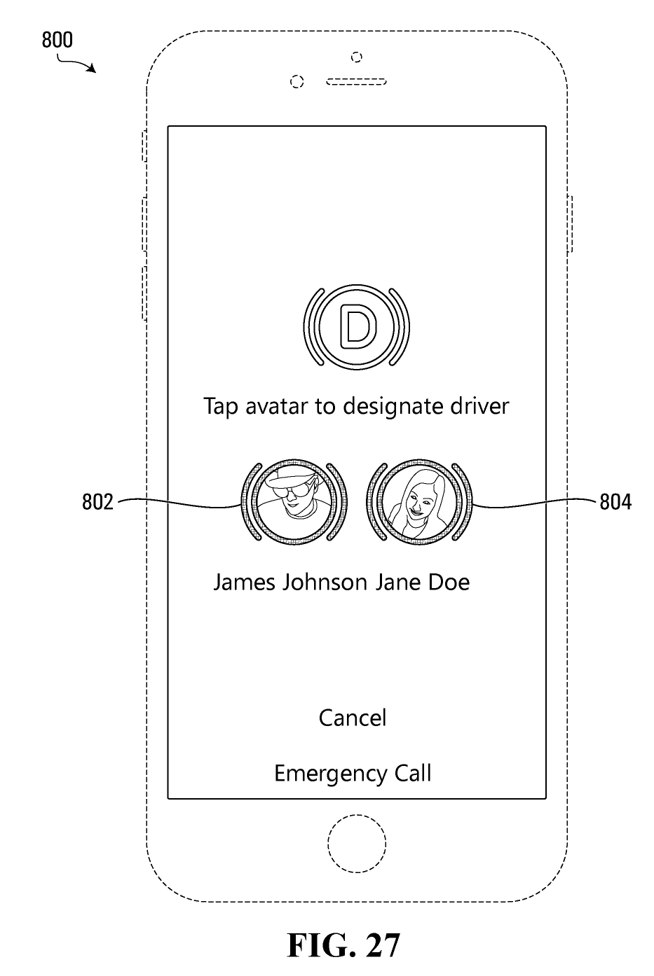

Block 746 of the flowchart 740 shown in FIG. 24 directs the mobile device processor 100 shown in FIG. 3 to cause the display 108 to display a user interface, for example as shown at 800 in FIG. 27 including representations of possible operator users. Referring to FIG. 27, the user interface 800 includes a selectable second user representation 802 and a selectable third user representation 804 representing the users 22 and 20 associated with the second and third mobile devices 524 and 526 respectively as shown in FIGS. 19 and 20.

In some embodiments, the mobile device 10 may have previously received user profile information from the second and third mobile devices 524 and 526 and stored the user profile information in the location 152 of the storage memory 104 and block 746 may direct the mobile device processor 100 to draw from the user profile information in presenting the user representations 802 and 804. In some embodiments, the selective access application may have been configured to initiate device detection and/or user information sharing periodically and/or upon start-up of the mobile device 10.

In some embodiments, the selective access application may detect the second and third mobile devices 524 and 526 shown in FIG. 19 by communicating using the interface 130 of the mobile device 10 shown in FIG. 3. The selective access application may send the second and third mobile devices a representation of the current user information stored in the location 150 of the storage memory 104 and the second and third mobile devices 524 and 526 may be configured to act generally similarly and send their respective user information to the mobile device 10 via respective interfaces 528 and 660 of the second and third mobile devices 524 and 526 (see FIGS. 21 and 22), for example. In some embodiments, the second and third mobile devices 524 and 526 may be configured to send respective user profile records, each having a format generally similar to the first user profile record 780 shown in FIG. 26 to the mobile device 10, and the mobile device 10 may receive the user profile records and store representations of the user profile records as other users information in the location 152 of the storage memory 104.

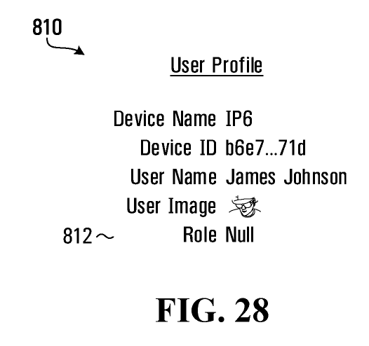

Referring to FIG. 28, there is shown a second user profile record 810, which may have been received from the second mobile device 524 and stored in the location 152 of the storage memory 104, in accordance with various embodiments. In various embodiments a third user profile record generally similar in format to the second user profile record 810 may have been received from the third mobile device 526 and stored in the location 152 of the storage memory 104.

Referring to FIGS. 24 and 27, block 746 may direct the mobile device processor 100 to retrieve user images and user names from the user profile records stored in the location 152 of the storage memory 104 and to display representations of the retrieved user images and user names as the selectable user representations 802 and 804 as shown in FIG. 27.

The user 16 may select one of the selectable user representations 802 or 804 to indicate that the user wishes to designate a user as an operator of the vehicle 14. In various embodiments, selection of one of the selectable user representations 802 or 804 may act as an operator designation.

Block 748 directs the mobile device processor 100 to receive the operator designation. In some embodiments, the user 16 may select the selectable second user representation 802 shown in FIG. 27 and block 748 may direct the mobile device processor 100 to receive the operator designation via the display 108. In some embodiments, block 748 may direct the mobile device processor 100 to, in response to receiving signals representing user selection of the second user representation, retrieve the second user profile record 810 associated with the second user representation from the location 152 of the storage memory 104 and thereby receive the second user profile record 810 from the location 152 of the storage memory 104.

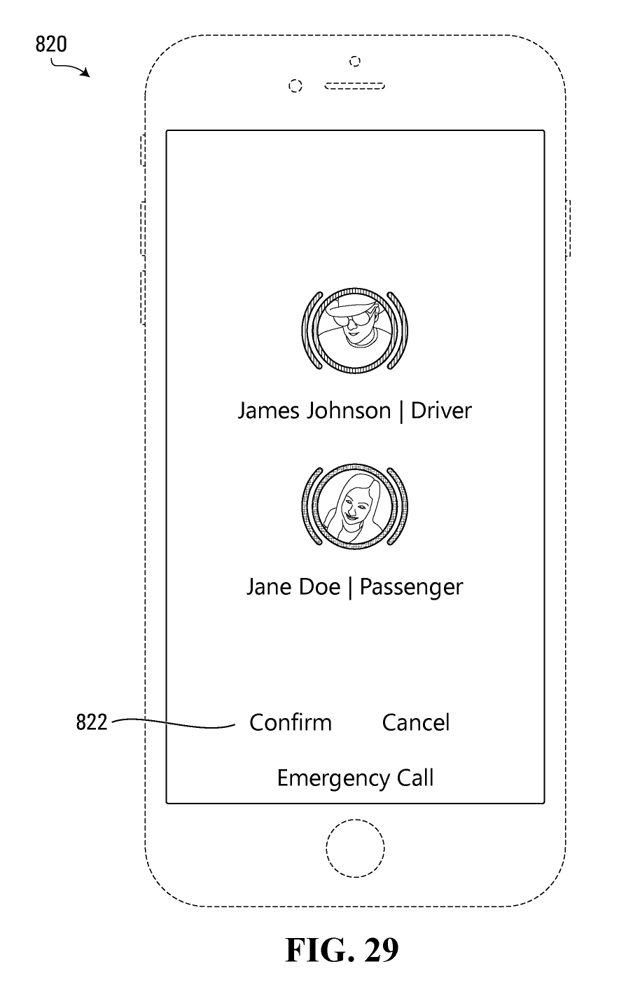

In some embodiments, block 748 of the flowchart 740 shown in FIG. 24 may direct the mobile device processor 100 shown in FIG. 3 to cause the display 108 to display a user interface for confirming the operator designation, for example, as shown at 820 in FIG. 29. Block 748 may direct the mobile device processor 100 to receive signals representing selection of a confirm element 822.

In some embodiments, signals representing selection of the confirm element 822 may act as part of the operator designation.

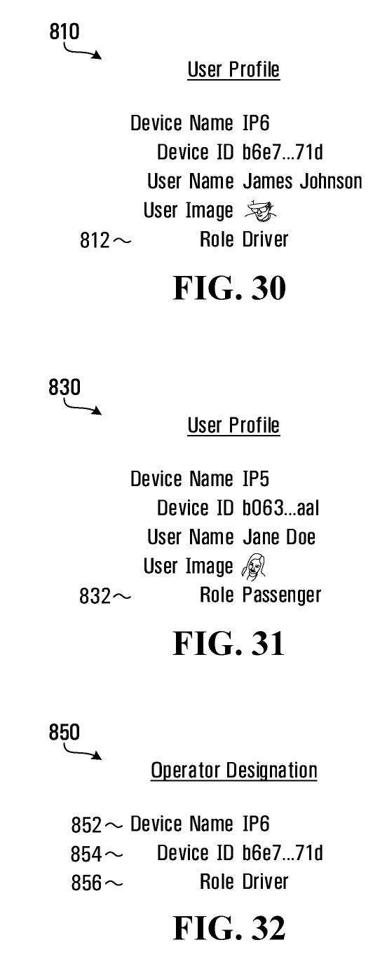

In some embodiments, in response to receiving the operator designation, block 748 may direct the mobile device processor 100 to update the second user profile record stored in the location 152 and associated with the operator designation. For example, in some embodiments, upon receiving selection of the second user representation 802, block 748 may direct the mobile device processor 100 to update the second user profile record 810 stored in the location 152 of the storage memory 104 to include a role designation field 812 storing “Driver” as shown in FIG. 30, which depicts an updated version of the second user profile record 810. In various embodiments, a role designation field storing “Driver” may indicate that the user associated with the profile record has been designated as the operator of the vehicle 14.

In some embodiments, the vehicle 14 may be operated by only one operator and so if one user is an operator, it may be assumed that the other users are passengers. In some embodiments, block 748 may direct the mobile device processor 100 to update user profile records associated with users that were not designated as operators to include role designations representing a role of passenger. Accordingly, in some embodiments, after block 748 has been executed, a third user profile record 830 shown in FIG. 31 may be stored in the location 152 of the storage memory 104 and may include a role designation field 832 set to “Passenger”.

Referring back to FIG. 23, after block 702 has been executed and a role designation has been received, the flowchart continues at block 704. Block 704 directs the mobile device processor 100 to cause a role designation message to be sent to an operator mobile device. In various embodiments, the role designation message may be an operator designation message and may represent, for example, the operator designation received at block 702.

In various embodiments, block 704 may direct the mobile device processor 100 to retrieve a user profile record that includes an operator role designation, from the location 152 of the storage memory 104 and to send an operator designation message to a mobile device associated with the device name and device identifier included in the retrieved user profile record. For example, where the second user profile record 810 as shown in FIG. 30 is stored in the location 152 of the storage memory 104, block 704 may direct the mobile device processor 100 to retrieve the second user profile record 810 and to transmit an operator designation message to the second mobile device 524 shown in FIG. 19 which is associated with a device name and device identifier that corresponds to the device name and device identifier included in the second user profile record 810. In some embodiments, block 704 may direct the mobile device processor 100 to transmit the operator designation message to all devices in the system 520. In some embodiments, block 704 may direct the mobile device processor 100 to transmit the operator designation message via the interface 130 of the I/O interface 106, for example.

The operator designation message may be configured to identify a device that is associated with the operator for which an operator designation was received at block 702. The operator designation message may include a representation of an operator designation record derived from the second user profile record 810 shown in FIG. 30. In some embodiments, block 704 may direct the mobile device processor 100 to transmit a JSON representation of an operator designation record, such as, for example as shown at 850 in FIG. 32, including a device name field 852, a device identifier field 854, and a role designation field 856. Block 704 may direct the mobile device processor 100 to retrieve values for the fields 852, 854, and 856 from the second user profile record 810 (see FIG. 30) stored at the location 152 of the storage memory 104.

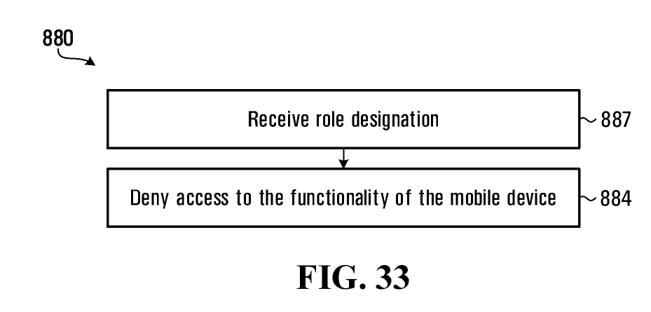

Upon receiving the representation of the operator designation record 850, the second mobile device 524 may execute blocks of code represented by a flowchart 880 shown in FIG. 33. In various embodiments, the flowchart 880 may be encoded in a block of code 570 of program memory 532 of the second mobile device 524 shown in FIG. 21, the block of code 570 being generally similar to the block of code 160 of the mobile device 10 shown in FIG. 3.

Referring to FIG. 33, the flowchart 880 begins with block 882 which directs a second mobile device processor 530 of the second mobile device 524 shown in FIG. 21 to receive a role designation. In some embodiments, the role designation may be an operator designation. For example, in some embodiments, block 882 may direct the second mobile device processor 530 to receive the representation of the operator designation record 850 transmitted by the mobile device 10 at block 704 of the flowchart 700 shown in FIG. 23, via the interface 528 of the I/O interface 536 shown in FIG. 21. In some embodiments, block 882 may direct the second mobile device processor 530 to store a representation of the operator designation record 850 in storage memory 534.

In some embodiments, block 882 may direct the second mobile device processor 530 to determine that the operator designation record 850 includes a device identifier and device name that corresponds to the current user profile and so block 882 may direct the second mobile device processor to update a current user profile record stored in location 550 of the storage memory 534 to reflect the role designation field 856 included in the operator designation record 850. For example, in some embodiments, a current user profile record associated with the second user may be stored in the location 550 of the storage memory 534 and may include a role designation field having a “Null” value as shown in the second user profile record 810 shown in FIG. 28, for example. Block 882 may direct the second mobile device processor 530 to update the current user profile record stored in the location 550 of the storage memory in accordance with the received operator designation record 850 to include a role designation field of “Driver” such that the current user profile record includes information as shown in the second user profile record 810 in FIG. 30.

Block 884 then directs the second mobile device processor 530 to deny access to the functionality of the second mobile device 524. In some embodiments block 884 may be initiated by the second mobile device 524 receiving a request for access to the functionality of the second mobile device 524. For example, in some embodiments, block 884 may include a block of code generally similar to the block 202 of the flowchart 200 shown in FIG. 3, for example.

Block 884 may direct the second mobile device processor 530 to, upon receiving the request for access, read the current user record stored in the location 550. Block 884 may direct the second mobile device processor 530 to determine whether the current user record includes a role designation that designates a disallowed or undesirable role for use and, if so, deny access to the functionality of the second mobile device 524. In various embodiments, the “Driver” role designation representing an operator designation may be disallowed and so, block 884 may direct the second mobile device processor 530 to, upon reading a user profile record such as the second user profile record 810 shown in FIG. 30, which includes a role designation of “Driver”, deny access to the second mobile device 524.

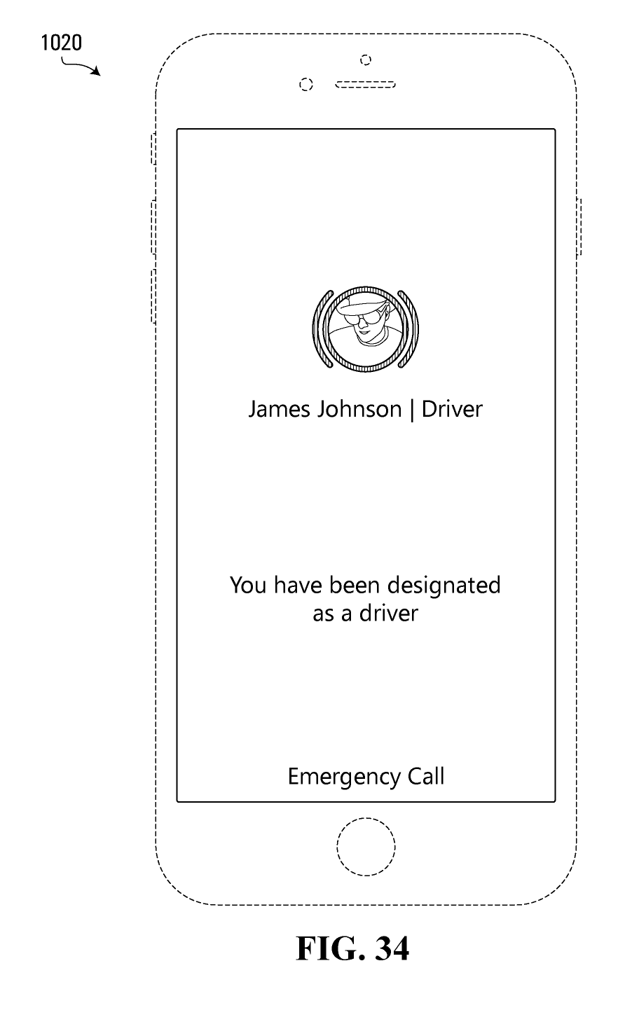

In some embodiments, block 884 may direct the second mobile device processor 530 to cause the display 538 to display a lock-out display 1020 as shown in FIG. 34, for example. In some embodiments block 884 may direct the second mobile device processor 530 to cause the display 1020 to not include any element similar to the selectable element 342 shown in FIG. 5, such that the second mobile device 524 cannot be unlocked.

In some embodiments, block 884 may include blocks of code generally similar to those included in the block 203 of the flowchart 200 shown in FIG. 4. For example, block 884 may include blocks of code generally similar to those included in the flowchart 260 shown in FIG. 6, such that the second mobile device processor 530 is directed to deny access only if the speed represented by the speed information is greater than a threshold speed. In some embodiments, however, block 884 may direct the second mobile device processor 530 to not proceed to block 204 of the flowchart 200 shown in FIG. 4. Thus, the user who has been designated as an operator may be locked out of their device except for approved one touch services, such as emergency calling. In some embodiments, this denial of access may keep a user who has been designated as an operator from being able to gain access to their mobile device, regardless of whether the operator is able to impersonate a passenger.

Referring back to FIG. 23, block 706 directs the mobile device processor 100 shown in FIG. 3 to cause a role designation message to be sent to a passenger mobile device. In some embodiments, the role designation message may be an operator designation message, as described above, for example. In some embodiments, block 706 may direct the mobile device processor 100 to retrieve the third user profile record 830 as shown in FIG. 31 from the location 152 of the storage memory 104 and to cause a role designation message to be sent to the third mobile device 526 identified by the device name and device identifier fields of the third user profile record 830. In some embodiments, block 706 may include code generally similar to that of block 704 but directing the mobile device processor 100 to send a representation of the operator designation record 850 to the third mobile device 526.

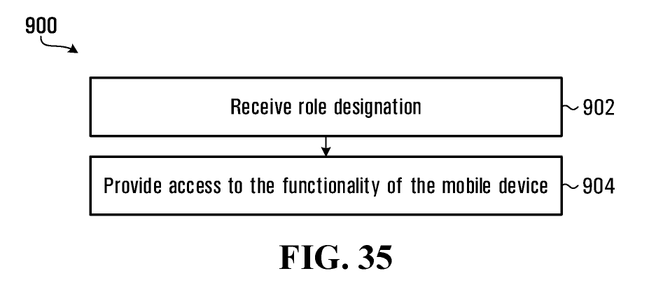

Referring to FIG. 35, flowchart 900 depicts blocks of code that may be included in blocks of code 650 of program memory 602 of the third mobile device 526 shown in FIG. 22, the block of code 650 being generally similar to the block of code 160 of the mobile device 10 shown in FIG. 3. The flowchart 900 begins with block 902 which directs a third mobile device processor 600 to receive an operator designation message. In various embodiments, for example, block 902 may direct the third mobile device processor 600 to receive a representation of the operator designation record 850.

Block 902 may direct the third mobile device processor 600 to compare the current user profile record stored in location 620 of storage memory 604 of the third mobile device 600 shown in FIG. 22 with that of the operator designation record 850 received and determine that the operator designation record 850 does not correspond to the current user profile record based on the device names and device identifiers not matching.

In some embodiments, it may be assumed that there is only one operator of the vehicle 14 and so block 902 may direct the third mobile device processor 600 to update the current user profile record stored in the location 620 of the storage memory 604 to reflect that the current user is not the operator and therefore is a passenger. Block 902 may direct the third mobile device processor 600 to update the current user profile record to include a role designation of “Passenger” which may replace a previous designation of “Null” for example. Accordingly, after block 902 has been executed, the location 620 of the storage memory 604 may store a current user record generally similar to the third user profile record 830 shown in FIG. 31.

Block 904 then directs the third mobile device processor 600 to provide access to the functionality of the third mobile device 526. In some embodiments block 904 may be initiated by the third mobile device 526 receiving a request for access to the functionality of the third mobile device 526. Block 904 may include a block of code generally similar to the block 202 of the flowchart 200 shown in FIG. 3, for example.

Block 904 may direct the third mobile device processor 600 to, upon receiving the request for access, read the current user record stored in the location 620. Block 904 may direct the third mobile device processor 600 to determine whether the current user record includes a role designation that designates an allowed or desirable role for use and, if so, provide access to the functionality of the third mobile device 526. In various embodiments, the “Passenger” role designation may be allowed and so, block 904 may direct the third mobile device processor 600 to, upon reading a user profile record such as the third user profile record 830 shown in FIG. 31, provide access to the third mobile device 526.

In some embodiments, block 904 may direct the third mobile device processor 600 to provide access by ceasing execution of codes from the selective access application stored in the blocks of code 650 of the program memory 602 and executing code from the operating system stored in the location 652 to cause normal operation of the third mobile device 526 to resume and to cause a default or home screen to be displayed by display 608 of the third mobile device 526, for example.

Referring back to FIG. 23, block 708 then directs the mobile device processor 100 to provide access to the functionality of the mobile device 10. In various embodiments, block 708 may direct the mobile device processor 100 to cease executing codes from the selective access application stored in the block of codes 160 of the program memory 102 and to execute code from the operating system stored in the block of codes 158 to cause normal operation of the mobile device 10 to resume and to cause a default or home screen to be displayed by the display 108, for example.

While the above embodiment has been described having regard to the system 520 including the mobile device 10, second mobile device 524, and third mobile device 526, in various embodiments, a generally similar configuration to that described above may be used with fewer or additional mobile devices. For example, in various embodiments, a system generally similar to the system 520 may include a plurality of passenger mobile devices and/or a plurality of operator mobile devices and blocks 706 and 704 of the flowchart 700 shown in FIG. 23 may be repeated to send role designation messages to each of the passenger and/or operator mobile devices. In some embodiments, a system may include only the mobile device 10 and the second mobile device 524 and no other passenger mobile devices and so it may be assumed that the second mobile device 524 is the operator. In such embodiments, blocks 702 and 706 of the flowchart 700 shown in FIG. 23 may be omitted.

Various Embodiments

Referring to FIG. 23, in some embodiments, the role designation received at block 702 of the flowchart 700 shown in FIG. 23 may be another role designation, such as, for example a passenger designation. In such embodiments, block 702 may direct the mobile device processor 100 to update role designations in the user profile information stored in the location 152 of the storage memory 104 for those roles which are known based on the received passenger designation. If an operator is not determinable from the received role designation, block 704 may be omitted in some embodiments and block 706 may direct the mobile device processor 100 to send a passenger designation message to the passenger mobile device for which a role of passenger has been designated.

In some embodiments, block 706 may direct the mobile device processor 100 to cause a passenger designation message to be sent to the passenger mobile device, the passenger designation message representing a passenger designation record including a device identifier field, a device name field, and a role designation field, wherein the role designation field stores a value of “Passenger”, for designating the user associated with the mobile device identified by the device identifier field and device name field as a passenger of the vehicle 14. In such embodiments, a block generally similar to block 902 of the flowchart 900 shown in FIG. 35 may direct a passenger mobile device processor to update a current user profile record accordingly.

While the particular flowchart 300 of FIG. 8 has been described above in accordance with various embodiments as included in the blocks 204 and 206 shown in FIG. 4, in various embodiments, the blocks 204 and 206 shown in FIG. 4 may include other blocks of code for directing the mobile device processor 100 to receive representations of one or more actions taken by a user and determining whether the one or more actions correspond to one or more passenger-related actions. Accordingly, in some embodiments, block 206 may direct the mobile device processor 100 to apply various different criteria to those described with reference to the flowchart 300 shown in FIG. 8 to determine whether one or more actions taken by a user correspond to one or more passenger-related actions.

For example, in various embodiments, the one or more passenger-related actions may comprise actions other than or in addition to holding the mobile device 10 upright, rotating the mobile device 10 more than a threshold rotation, and providing user input, and so the at least one criterion applied may differ accordingly.

In various embodiments, for example, the one or more passenger-related actions may involve orienting the mobile device 10 substantially vertically in front of the user and rotating the mobile device about 180 degrees to the left before providing user input. In some embodiments, this may be particularly difficult to do by a driver in a country or region where the driver's position is normally on the left side of the vehicle 14.

In various embodiments, for example, the one or more passenger-related actions may involve orienting the mobile device 10 substantially vertically in front of the user and rotating the mobile device about 180 degrees to the right before providing user input. In some embodiments, this may be particularly difficult to do by a driver in a country where the driver's position is normally on the right side of the vehicle 14.

In some embodiments, the one or more passenger-related actions may involve moving the mobile device 10 through a predefined path or arc. In some embodiments, the mobile device 10 may be configured to determine, for example, using at least the accelerometer 107, whether the mobile device has been moved through the predefined path or arc.

In various embodiments, the one or more passenger-related actions may involve orienting the mobile device 10 in an orientation wherein the display 108 is facing the user, but on its side in landscape mode before rotating the mobile device 10 and providing user input.

In some embodiments, the criteria for determining whether the one or more actions correspond to the one or more passenger-related actions could be based on the environment 12 surrounding the mobile device 10.

In various embodiments, block 204 may direct the mobile device processor 100 to receive the representations of the one or more actions in different ways, such as, for example, by using a camera to capture the representations of the one or more actions

In various embodiments, the mobile device 10 may be configured to automatically provide access when certain criteria are met. In some embodiments, various criteria for automatically providing access may be applied during execution of the block 203 of the flowchart 200 shown in FIG. 4. For example, as described above having regard to the flowchart 260 shown in FIG. 6, in some embodiments, access may be provided if the mobile device 10 is determined to be moving at a speed that is less than or equal to a threshold speed.

In some embodiments, block 203 of the flowchart 200 shown in FIG. 4 may include codes for directing the mobile device processor 100 to determine whether the mobile device 10 is in a location where use of a device may be allowed or considered safe. For example, in some embodiments, block 203 may include codes which direct the mobile device processor 100 to retrieve a current location from the GPS receiver 116 via the interface 129 and compare the current location with a predetermined set of safe locations wherein use of the device is allowed. Block 203 may direct the mobile device processor 100 to provide access to functionality of the mobile device 10 if the current location corresponds to a safe location.

In some embodiments, some locations, paths, routes, and/or corridors may be considered as safe locations for using the mobile device 10, but only if the device is determined to be on a particular type of vehicle. For example, in some embodiments, mass transit locations, paths, or routes, such as airport runways, train tracks, or bus routes, may be considered safe locations if the mobile device 10 is determined to be on an airplane, train, or bus respectively, since it may be assumed in some embodiments that the user using the device is a passenger on such vehicles.

For example, in some embodiments, a sensed altitude or height above the ground of more than an airplane threshold height at a location that corresponds to an airport runway may be indicative that the mobile device 10 is being used in a plane. Accordingly, in some embodiments, block 203 of the flowchart 200 shown in FIG. 4 may include codes for directing the mobile device processor 100 to receive or retrieve a current location from the GPS receiver 116 via the interface 129 and compare the current location with a predetermined set of airport locations. Block 203 may direct the mobile device processor 100 to, if the current location corresponds to an airport location, receive or determine an altitude of the mobile device 10 using the barometer 113 via the interface 125 and compare the altitude with an airplane threshold height. Block 203 may direct the mobile device processor 100 to, if the altitude is greater than the airport threshold height, provide access to functionality of the mobile device 10.

The airport threshold height may be chosen as a height above which it may be assumed that the mobile device 10 is on an airplane and not in a car, truck or other automobile. For example, in some embodiments, the airport threshold height may be about 2.5 meters.

In some embodiments, designated vehicles, such as mass transit vehicles, buses, or trains, may be associated with identifiers, keys, or codes, which may be obtainable while on the vehicles, or when entering the vehicles. The identifiers may each be associated with a location, path, or route which may be considered as a safe location for using the mobile device 10, if the device has received the indicator to indicate that the mobile device 10 is on the vehicle. For example, in some embodiments, an identifier, which may be encoded in a QR code, for example, may be displayed near an entry to a vehicle such as a bus, and the user 16 may input the identifier into the mobile device 10, such as, for example, by scanning the QR code using the camera 112 via the interface 128.

In some embodiments, block 203 of the flowchart 200 shown in FIG. 4 may include codes for directing the mobile device processor 100 to receive the identifier from the camera 112 via the interface 128. Block 203 may direct the mobile device processor 100 to determine what safe locations, paths, or routes are associated with the identifier. For example, in some embodiments, safe locations may be associated with identifiers in the storage memory 104 and block 203 may direct the mobile device processor 100 to retrieve or receive the safe locations from the storage memory 104. In some embodiments, safe locations may be associated with identifiers in storage memory of a server which the mobile device 10 is able to communicate with using the I/O interface 106, for example, and block 203 may direct the mobile device processor 100 to communicate with the server and retrieve or receive the safe locations from the server.

Block 203 may direct the mobile device processor 100 to receive or retrieve a location of the mobile device 10 using the GPS receiver 116 via the interface 129. Block 203 may direct the mobile device processor 100 to determine whether the location of the mobile device 10 corresponds to the safe locations associated with the identifier. Block 203 may direct the mobile device processor 100 to, if the location of the mobile device 10 corresponds to the safe locations, provide access to functionality of the mobile device 10.

In some embodiments, block 203 may direct the mobile device processor 100 to determine whether the user is walking using a combination of the speed the device is traveling at (by measuring positional changes using GPS for example) and by detecting the footsteps of the user using the accelerometer to detect impacts. In some embodiments, block 203 may direct the mobile device processor 100 to provide access to functionality of the mobile device 10 if it is determined that the user is walking.

In some embodiments, when a crash has occurred or has been detected, the mobile device 10 may provide access to the functionality of the mobile device. In some embodiments, block 203 may include code for directing the mobile device processor 100 to determine whether a crash has occurred and if a crash has occurred to provide access to functionality of the mobile device 10. In some embodiments, the mobile device 10 may be configured to determine whether a crash has occurred by receiving and analyzing location data received from the GPS receiver 116 via the interface 129 and accelerometer information received from the accelerometer via the interface 120. For example, in some embodiments, the mobile device 10 may be configured to keep a record of the speed of the mobile device, based on the location information, and to determine or detect when the speed suddenly stops using the accelerometer information. The mobile device 10 may be configured to compare the current speed based on the location information to the historical speed of the mobile device 10 for the last few seconds, for example. If the historical speed is greater than a threshold vehicle speed, this may indicate that the mobile device 10 was in a vehicle. If the mobile device 10 determines that a crash has occurred, the mobile device 10 may be configured to store a crash indicator in the storage memory 104. Block 203 may direct the mobile device processor 100 to determine whether the crash indicator stored in the storage memory 104 indicates that a crash has occurred. Block 203 may direct the mobile device processor 100 to, if the crash indicator indicates that a crash has occurred, provide access to functionality of the mobile device 10.

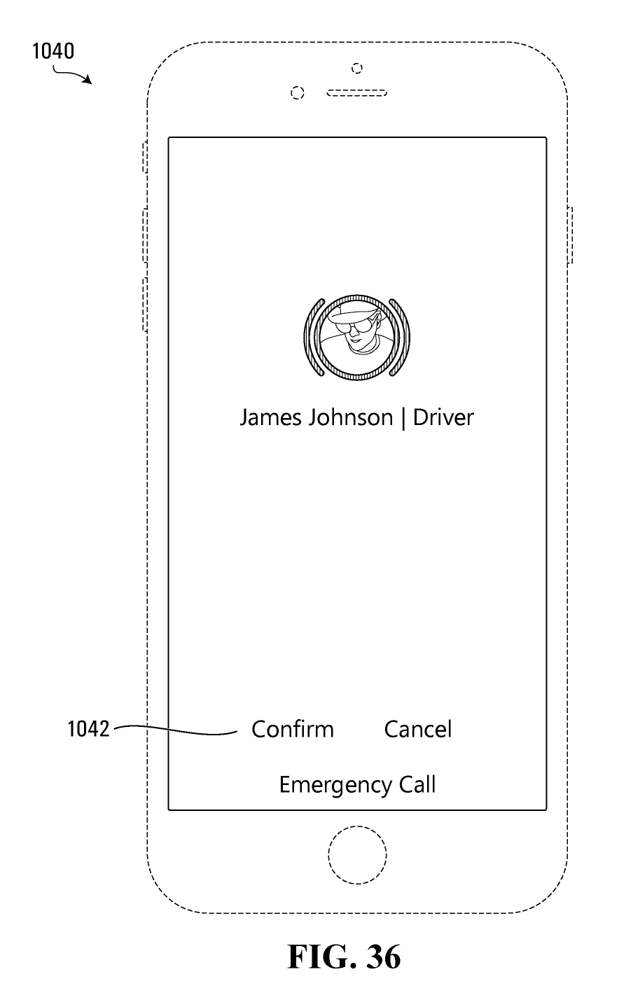

In some embodiments, passenger users of all devices in a vehicle which are connected, such as for example as shown in the system 520 shown in FIG. 19 must agree that a role designation is correct before roles of the users are designated. For example, in some embodiments, block 702 of the flowchart 700 shown in FIG. 23 may direct the mobile device processor 100 to upon receiving the operator designation, cause an operator designation confirmation message to be sent to all devices in the system 520 as determined from the user profile information stored in the location 152, for example. The mobile devices that are associated with a user that has not been designated as an operator at block 702, such as the third mobile device 526 of the system 520 shown in FIG. 19, may be configured to receive the operator designation confirmation message and to cause a display, such as the display 608 of the third mobile device 526, to display a designation confirmation display as shown at 1040 in FIG. 36, for example.

If the user of the third mobile device 526 agrees with the designation displayed, the user may select a confirm element 1042 and the third mobile device 526 may be configured to receive the confirmation via the display 108 and send a representation of the confirmation to the mobile device 10. Block 702 may direct the mobile device processor 100 to receive the confirmation and to proceed with updating the user profiles as described above, once confirmation has been received. In some embodiments, block 702 may direct the mobile device processor 100 to wait until confirmation is received from a minimum number of mobile devices. In some embodiments, the minimum number may be the total number of passengers in the vehicle 14 associated with a device in accordance with the user profile information stored in the location 152 of the storage memory 104.

In some embodiments, the mobile device 10 may be configured to reset the role designation associated with the user 16 of the mobile device 10, when it is determined that the mobile device 10 and thus the user 16 has left the vehicle 14. For example, in some embodiments, the mobile device 10 may be configured to reset the role designation field 788 of the first user profile record 780 stored in the location 150 of the storage memory 104 when a connection between the mobile device 10 and the second mobile device 524, which is associated with the operator user, is lost.

In some embodiments, heading may be used to ensure that the unlock motion detection is not engaged by the vehicle moving. For example, the mobile device 10 may be configured such that detection of turning the phone 180 degrees is not be triggered by the vehicle turning.

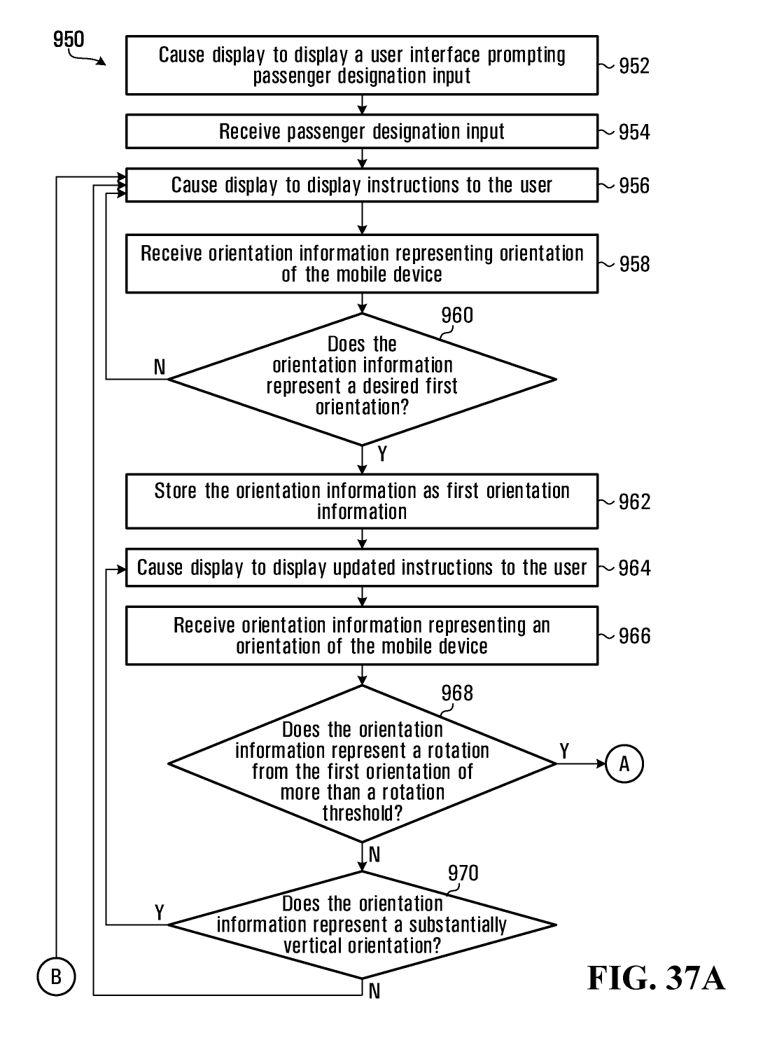

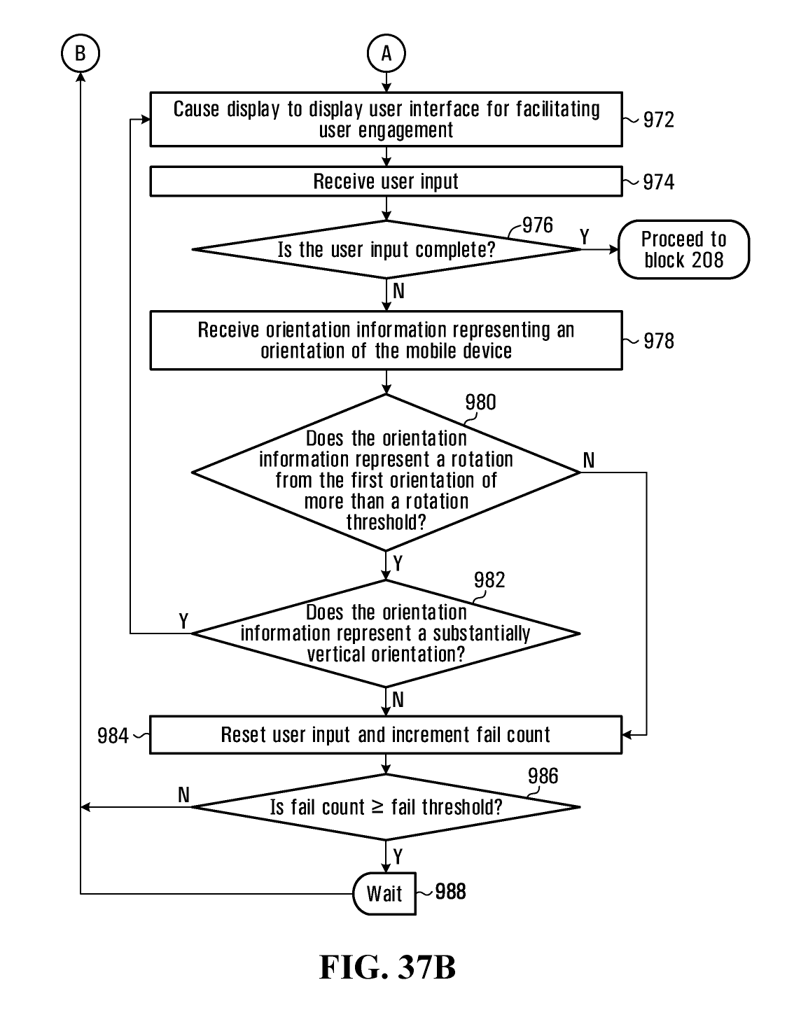

Referring now to FIGS. 37A and 37B, there is provided a flowchart 950 depicting blocks of code for execution by the mobile device processor 100 that may be used to implement the blocks 204 and 206 of the flowchart 200 shown in FIG. 4, in accordance with various embodiments. In some embodiments, the flowchart 950 may provide functionality that is generally similar to that described above having regard to the flowchart 300 shown in FIG. 8.

The flowchart 950 shown in FIGS. 37A and 37B begins with blocks 952 and 954 which may be generally similar to the blocks 302 and 304 of the flowchart 300 shown in FIG. 8. Block 956 directs the mobile device processor 100 to cause the display 108 to display instructions to the user. In some embodiments, block 956 may implement functionality generally similar to the blocks 308 and 317 shown in FIG. 8. Block 956 may direct the mobile device processor 100 to cause the display 108 to provide an instructions display, for example, as shown at 360 in FIG. 9 that updates in accordance with the orientation information received or updated and stored in the location 142 of the storage memory 104 at blocks 958, 966, or 978, for example.

Block 958 of the flowchart 950 shown in FIGS. 37A and 37B directs the mobile device processor 100 to receive orientation information representing orientation of the mobile device 10. Block 958 may be generally similar to the block 308 of the flowchart 300 shown in FIG. 8.

Block 960 directs the mobile device processor 100 to determine whether the orientation information represents a desired first orientation. In various embodiments, the desired first orientation may be one in which the mobile device 10 is substantially vertical and the display 108 is facing backwards in the vehicle 14 towards the user 16. Block 960 may direct the mobile device processor 100 to determine whether the mobile device 10 is substantially vertical and the display 108 faces a direction substantially opposite to a direction of movement of the mobile device 10. In some embodiments, block 960 may include code generally similar to some of the code described above having regard to block 310 of the flowchart 300 shown in FIG. 8.

If at block 960 of the flowchart 950 shown in FIGS. 37A and 37B, the mobile device processor 100 determines that the orientation information represents a desired first orientation, block 960 directs the mobile device processor 100 to proceed to block 962. Otherwise, block 960 directs the mobile device processor 100 to return to block 956. Accordingly, blocks 956-960, may be executed repeatedly or continuously until the orientation information represents a desired first orientation. In various embodiments, the mobile device 10 may be considered to be in a first access pre-conditioning state when executing blocks 956-960.

Block 962 directs the mobile device processor 100 to store the orientation information as first orientation information. In some embodiments, block 962 may be generally similar to block 312 as shown in FIG. 8, but in some embodiments block 962 may direct the mobile device processor 100 to overwrite or update any orientation information stored in the location 144 of the storage memory 104.

Block 964 of the flowchart 950 shown in FIGS. 37A and 37B directs the mobile device processor 100 to cause the display 108 to display updated instructions to the user 16. Block 964 may direct the mobile device processor 100 to cause the display 108 to present the updated instructions display 400 as shown in FIG. 13, for example, to indicate to the user 16 that the mobile device 10 has been determined to be substantially vertical and that the user 16 should now rotate the device 180 degrees, since it may be assumed that the orientation was sensed to be substantially vertical at block 960, in order for the process to have come to block 964. In various embodiments, block 964 may include code generally similar to some of the code described above and included in the block 317 of the flowchart 300 shown in FIG. 8.

Block 966 may direct the mobile device processor 100 to receive orientation information representing an orientation of the mobile device 10. Block 966 may be generally similar to the block 308 of the flowchart 300 shown in FIG. 8, for example.

Block 968 of the flowchart 950 shown in FIGS. 37A and 37B directs the mobile device processor 100 to determine whether the orientation information represents a rotation from the first orientation of more than a rotation threshold. Block 968 may be generally similar to block 316 of the flowchart 300 shown in FIG. 8.

If at block 968 the mobile device processor 100 determines that the orientation information represents a rotation from the first orientation of more than a rotation threshold, block 968 directs the mobile device processor 100 to proceed to block 972 shown in FIG. 37B. Otherwise, block 968 directs the mobile device processor 100 to proceed to block 970.

Block 970 of the flowchart 950 shown in FIGS. 37A and 37B directs the mobile device processor 100 to determine whether the orientation information represents a substantially vertical orientation. Block 970 may direct the mobile device processor 100 to make this determination, generally as described above having regard to block 310 of the flowchart 300 shown in FIG. 8. If at block 970 the mobile device processor 100 determines that the orientation information represents a substantially vertical orientation, block 970 directs the mobile device processor 100 to return to block 964. Accordingly, as long as the mobile device 10 remains substantially vertical, blocks 964-970 may be executed repeatedly or continuously until the orientation information represents a rotation from the first orientation of more than a rotation threshold. In various embodiments, the mobile device 10 may be considered to be in a second access pre-conditioning state when executing blocks 964-970.

If at block 970 the mobile device processor 100 determines that the mobile device 10 is not substantially vertical, block 970 directs the mobile device processor 100 to return to block 956. Accordingly, if the mobile device 10 is no longer substantially vertical, the mobile device 10 returns to the first access pre-conditioning state.

Referring now to FIG. 37B, blocks 972, 974, and 976 direct the mobile device processor 100 to cause the display 108 to display a user interface for facilitating user engagement, receive user input, and determine whether the user input is complete. Blocks 972-976 may be generally similar to the blocks 318-322 of the flowchart 300 described above and shown in FIG. 8.

If at block 976, the mobile device processor 100 determines that the user input is complete, block 976 directs the mobile device processor 100 to proceed to block 208 of the flowchart 200 as shown in FIG. 4, and as described above. Otherwise, if the user input is not complete, block 976 directs the mobile device processor 100 to proceed to block 978.

Block 978 of the flowchart 950 shown in FIGS. 37A and 37B directs the mobile device processor 100 to receive orientation information representing an orientation of the mobile device 10. Block 978 may be generally similar to the block 308 of the flowchart 300 shown in FIG. 8, for example.

Block 980 directs the mobile device processor 100 to determine whether the orientation information represents a rotation from the first orientation of more than a rotation threshold. Block 980 may be generally similar to block 316 of the flowchart 300 shown in FIG. 8.

If at block 980 the mobile device processor 100 determines that the orientation information represents a rotation from the first orientation of more than a rotation threshold, block 980 directs the mobile device processor 100 to proceed to block 902 shown in FIG. 37B. Otherwise, block 980 directs the mobile device processor 100 to proceed to block 984.

Block 982 of the flowchart 950 shown in FIGS. 37A and 37B directs the mobile device processor 100 to determine whether the orientation information represents a substantially vertical orientation. Block 982 may direct the mobile device processor 100 to make this determination, generally as described above having regard to block 310 of the flowchart 300 shown in FIG. 8. If at block 982 the mobile device processor 100 determines that the orientation information represents a substantially vertical orientation, block 982 directs the mobile device processor 100 to return to block 972. Accordingly, as long as the mobile device 10 remains substantially vertical and rotated more than the rotation threshold from the first orientation, blocks 972-982 may be executed repeatedly or continuously, until the user input is complete and the mobile device processor 100 is directed by block 976 to proceed to block 208. In various embodiments, the mobile device 10 may be considered to be in the access assessment state when executing blocks 972-982.

As described above, if at block 980 or 982 is determined that the orientation information does not represent a rotation of more than a rotation threshold from the first orientation or does not represent a substantially vertical orientation, the mobile device processor 100 is directed to proceed to block 984.

Proceeding to block 984 may be considered as leaving the access assessment state. In some embodiments, proceeding to block 984 may be considered a failure of the cognitive test provided while the mobile device 10 is in the access assessment state.

Block 984 directs the mobile device processor 100 to reset the user input and increment the fail count. In some embodiments, block 984 may include code generally similar to code included in the block 317 of the flowchart 300 shown in FIG. 8 in accordance with some embodiments. Block 984 may direct the mobile device processor 100 to reset the user input record 480 stored in the location 148 of the storage memory 104, such that the next time block 972 is executed the user is provided with a user interface that does not have any portion of code entered.

Block 986 of the flowchart 950 shown in FIGS. 37A and 37B then directs the mobile device processor 100 to determine whether the fail count meets a fail threshold criterion. For example, block 986 may direct the mobile device processor 100 to determine whether the fail count field 502 of the user input record 480 stored in the location 148 of the storage memory 104 shown in FIG. 3 holds a value greater than or equal to a fail threshold value. Block 986 may direct the mobile device processor 100 to proceed to block 988 and wait for a wait time period if the fail count meets the fail threshold criterion. Otherwise, block 986 directs the mobile device processor 100 to return to block 956.

Block 988 directs the mobile device processor 100 to wait. Block 988 may direct the mobile device processor 100 to cause the display 108 to display the lock-out display 504 shown in FIG. 16, for example, for a predetermined wait time period. Block 988 may direct the mobile device processor 100 to reset the fail count field 502 of the user input record 480 shown in FIGS. 15 to 0.

Accordingly, in various embodiments, if the user fails during the access assessment state, the mobile device processor 100 is directed to return to block 956 and the mobile device 10 returns to the first access pre-conditioning state.

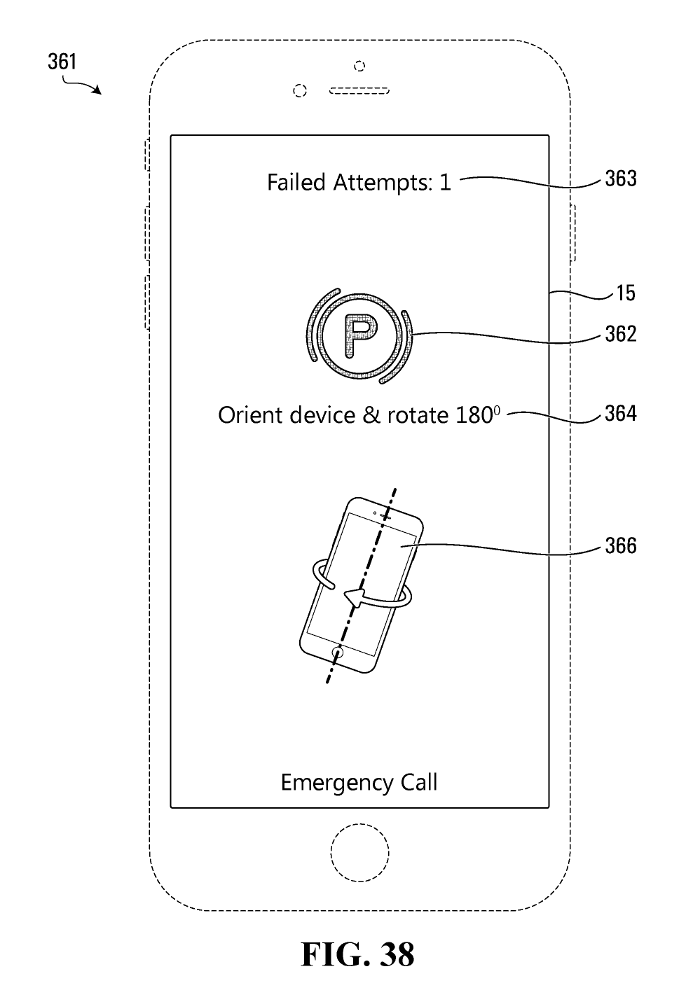

Referring to FIG. 38, there is shown an instructions display 361 including generally similar elements to the instructions display 360 shown in FIG. 9 which may be displayed by the display 108 in accordance with various embodiments. The instructions display 361 includes a failed attempts counter 363. In various embodiments, the failed attempts counter 363 may reflect the number stored in the fail count field 502 of the user input record 480. In some embodiments, block 306 of the flowchart 300 shown in FIG. 8 may direct the mobile device processor 100 to cause the display 108 to display the instructions display 361 shown in FIG. 38. In various embodiments, the failed attempts counter 363 may be included in any or all of the displays and/or user interfaces described herein.

Referring to FIG. 14, in various embodiments, the user interface 460 may include a countdown timer 461. In various embodiments, the countdown timer may be dynamic and count down the time remaining for the user to complete the user input. Referring to FIG. 18, in various embodiments, the user interface 1000 may include a countdown timer 1001, which may be generally similar to the countdown timer 461, for example.

Referring to FIG. 16, the lock-out display may include a countdown timer 505. In various embodiments, the countdown timer may be dynamic and count down the wait time remaining before the lock-out display is no longer displayed.

While specific embodiments of the invention have been described and illustrated, such embodiments should be considered illustrative of the invention only and not as limiting the invention as construed in accordance with the accompanying claims. In the embodiments described above, it will also be understood that “including” is used in a non-limiting way and means “including but not limited to” wherever used.

1. A method for selectively facilitating access to functionality of a mobile device by a user in a vehicle, the method comprising:
causing at least one processor to receive a request for access to the functionality of the mobile device;
causing the at least one processor to initially cause access to the functionality of the mobile device to be denied;
causing the at least one processor to receive representations of one or more actions taken by the user;
causing the at least one processor to determine whether the one or more actions correspond to one or more passenger-related actions that if taken by the user would indicate that the user is not operating the vehicle by determining whether the representations of the one or more actions taken by the user meet at least one passenger-related action criterion; and
causing the at least one processor to, in response to determining that the one or more actions meet the at least one passenger-related action criterion, cause the user to be provided access to the functionality of the mobile device.

2. The method of claim 1 further comprising causing the at least one processor to produce signals for causing a display of the mobile device to display instructions to the user, said instructions prompting the user to take the one or more passenger-related actions.

3. The method of claim 1 wherein the one or more passenger-related actions comprise at least one action that is more difficult for an operator of the vehicle to perform than for a user of the vehicle who is not an operator to perform.

4. The method of claim 3 wherein the one or more passenger-related actions comprise rotating the mobile device more than a threshold rotation from a first position and interacting with a dynamic user interface while the mobile device is rotated more than the threshold rotation.

5. The method of claim 1 wherein the representations of the one or more actions comprise mobile device orientation information representing at least one orientation of the mobile device and wherein causing the at least one processor to apply the at least one passenger-related action criterion comprises causing the at least one processor to determine whether the mobile device orientation information meets at least one orientation threshold.

6. The method of claim 5 wherein causing the at least one processor to determine whether the mobile device orientation information meets the at least one orientation threshold comprises causing the at least one processor to produce signals for causing at least one display to display a user interface for facilitating user engagement and receiving user input and causing the at least one processor to determine whether the mobile device orientation information meets the at least one orientation threshold while the user interface is displayed.

7. The method of claim 6 wherein causing the at least one processor to produce signals for causing the at least one display to display the user interface comprises causing the at least one processor to produce signals for causing the at least one display to display the user interface when the mobile device orientation meets the orientation threshold and causing the at least one processor to cease producing signals for causing the at least one display to display the user interface when the mobile device orientation does not meet the orientation threshold.

8. The method of claim 7 wherein the user interface includes at least one moving element for selection by the user.

9. The method of claim 5 wherein the mobile device orientation information comprises first orientation information representing orientation of the mobile device at a first time and second orientation information representing orientation of the mobile device at a second time and wherein causing the at least one processor to determine whether the mobile device orientation information meets the orientation threshold comprises causing the at least one processor to determine whether the second orientation represents a rotation from the first orientation of more than a rotation threshold.

10. The method of claim 9 wherein the rotation threshold is greater than about 90 degrees.

11. The method of claim 9 wherein causing the at least one processor to determine whether the mobile device orientation information meets the orientation threshold comprises causing the at least one processor to determine whether the first mobile device orientation represents a substantially vertical orientation of the mobile device wherein the display of the mobile device is substantially vertical before causing the at least one processor to determine whether the second mobile device orientation represents a rotation from the first mobile device orientation of more than a rotation threshold.

12. The method of claim 11 wherein the first mobile device orientation represents the substantially vertical orientation when the mobile device is within a threshold angle of a vertical orientation.

13. The method of claim 12 wherein the threshold angle is about 15 degrees.

14. The method of claim 1 wherein causing the at least one processor to initially cause access to the functionality of the mobile device to be denied comprises:
causing the at least one processor to receive speed information representing a speed of the mobile device;
causing the at least one processor to determine whether the speed represented by the speed information is greater than a threshold speed; and
causing the at least one processor to, in response to determining that the speed is greater than the threshold speed, initially cause access to the functionality of the mobile device to be denied.

15. The method of claim 1 wherein the user is a first user of a plurality of users comprising one or more additional users other than the first user and wherein causing the at least one processor to cause the user to be provided access to the functionality of the mobile device comprises causing the at least one processor to receive at least one role designation associated with at least one of the one or more additional users.

16. The method of claim 15 further comprising:
causing the at least one processor to, in response to receiving the at least one role designation, cause one or more signals to be transmitted to an operator mobile device associated with an operator user of the one or more additional users for causing the operator mobile device to deny access by the operator user to functionality of the operator mobile device.

17. The method of claim 15 further comprising:
causing the at least one processor to, in response to receiving the at least one role designation, cause one or more signals to be transmitted to a passenger mobile device associated with a passenger user who is not the operator user for causing the passenger mobile device to provide access to the passenger user to functionality of the passenger mobile device.

18. The method of claim 15 wherein the at least one role designation comprises an operator designation.

19. An apparatus for selectively facilitating access to functionality of a mobile device by a user in a vehicle, the apparatus comprising at least one processor configured to perform the method of claim 1.

20. A non-transitory computer-readable medium having stored thereon codes which, when executed by at least one processor, cause the at least one processor to perform the method of claim 1.

21. A system for selectively facilitating access to functionality of a mobile device by a user in a vehicle, the system comprising:
means for receiving a request for access to the functionality of the mobile device;
means for causing access to the functionality of the mobile device to be denied;
means for receiving representations of one or more actions taken by the user;
means for determining whether the one or more actions correspond to one or more passenger-related actions that if taken by the user would indicate that the user is not operating the vehicle by determining whether the representations of the one or more actions taken by the user meet at least one passenger-related action criterion; and
means for, in response to determining that the one or more actions meet the at least one passenger-related action criterion, causing the user to be provided access to the functionality of the mobile device.

22. A computer-implemented method of selectively facilitating access to functionality of a mobile device by a user in a vehicle, the method comprising:
receiving a request for access to the functionality of the mobile device;
denying access to the functionality of the mobile device;
receiving representations of one or more actions taken by the user;
determining whether the representations of the one or more actions correspond to one or more passenger-related actions that indicate that the user is not operating the vehicle by determining whether the representations of the one or more actions taken by the user meet at least one passenger-related action criterion; and
in response to determining that the one or more actions meet the at least one passenger-related action criterion, providing access to the functionality of the mobile device.
